(19) United States
(12) Patent Application Publication
(10) Pub. No.: US 2012/0002011 A1
(43) Pub. Date: Jan. 5, 2012

(54) DISPLAY DEVICE AND VIDEO SYSTEM

(76) Inventors: Shuji INOUE, Osaka (JP); Kazuhiro Mihara, Osaka (JP); Seiji Nakazawa, Osaka (JP)

(21) Appl. No.: 13/226,880

(22) Filed: Sep. 7, 2011

Related U.S. Application Data
(63) Continuation of application No. PCT/JP2011/000469, filed on Jan. 28, 2011.

(30) Foreign Application Priority Data
Mar. 26, 2010 (JP) 2010-073189

(51) Int. Cl. H04N 13/00; H04N 5/073

(52) U.S. Cl. 348/43; 348/512; 348/E05.015; 348/E13.071

(57) ABSTRACT

A display device including an input portion into which a reference signal with a predetermined frequency is input, a transmitter for transmitting a synchronization signal which is synchronized with display of video frame image, a determination portion for determining an intermittent transmission cycle including a first period in which the synchronization signal is transmitted and a second period without transmission of the synchronization signal on the basis of the reference signal, and a transmission controller for controlling the transmitter so that the synchronization signal is transmitted in the first period except for the second period. The determination portion adjusts a timing of the first period to avoid interference between the synchronization signals.

### TECHNICAL FIELD

The present invention is related to a display device and a video system for providing videos which are stereoscopically viewed by viewers.

### BACKGROUND ART

Recent progresses in video technologies have brought various developments of video systems for providing videos (three-dimensional videos) which are stereoscopically viewed by viewers. For example, Patent Document 1 suggests technologies which use two display portions to make a video stereoscopically viewed. A right frame image to be viewed by the right eye is displayed on one display portion whereas a left frame image to be viewed by the left eye is displayed on the other display portion. The viewer views the right frame image with the right eye and views the left frame image with the left eye, so that the viewer stereoscopically perceives the video. Patent Document 2 discloses video signal processing technologies for making a viewer stereoscopically perceive a video through an eyeglass device.

Patent Documents 3 and 4 disclose technologies for causing the viewer to perceive a video under communication of synchronization signals, which are synchronized with display of frame images, between a display device configured to display a stereoscopic video and an eyeglass device configured to assist in viewing the stereoscopic video. The display device of the video system disclosed in Patent Documents 3 and 4 transmits a synchronization signal in synchronism with the display of the video frame image, so that the eyeglass device executes stereoscopic view assistance for assisting in viewing the video. The eyeglass device executes the stereoscopic view assistance in synchronism with the display of the video frame image, so that the viewer may view the video displayed by the display device as a stereoscopic video.

Interference between synchronization signals is one of problems associated with technologies standing on the communication of the synchronization signals between the display device and the eyeglass device. For example, an audio shop arranges and retails a lot of display devices, so that the interference between the synchronization signals becomes more serious issues. For example, if a stereoscopic video displayed by a specific display device is viewed by a viewer under assistance of an eyeglass device, the eyeglass device is then operated by a synchronization signal from another display device, so that the viewer may not comfortably enjoy viewing the stereoscopic video.

Patent Document 1: Japanese Patent Application Publication No. H8-37673

Patent Document 2: Japanese Patent Application Publication No. 2008-209476

Patent Document 3: Japanese Patent Application Publication No. H7-322300

Patent Document 4: Japanese Patent Application Publication No. H8-317426

### SUMMARY OF THE INVENTION

It is an object of the present invention to provide a display device and a video system which make it less likely to cause interference between synchronization signals.

The display device according to one aspect of the present invention for transmitting a first synchronization signal in synchronism with display of a video frame image includes: an input portion into which a reference signal with a predetermined frequency is input, the reference signal serving as a reference to be used by another display device configured to intermittently transmit a second synchronization signal on a predetermined transmission cycle; a determination portion configured to determine an intermittent transmission cycle based on the reference signal so that the intermittent transmission cycle becomes as long as the predetermined transmission cycle and includes a first period during which the first synchronization signal is transmitted and a second period without transmission of the first synchronization signal; and a transmitter which transmits the first synchronization signal during the first period except for the second period, wherein the determination portion adjusts a timing of the first period to avoid interference between the first and second synchronization signals.

The video system according to another aspect of the present invention includes: a first display device configured to display a first video; a second display device configured to display a second video; a first eyeglass device configured to assist in viewing the first video; and a second eyeglass device configured to assist in viewing the second video, wherein each of the first and second display devices comprises: an input portion into which a reference signal with a predetermined frequency is input; a transmitter configured to transmit a synchronization signal which is synchronized with a frame image of a video; a determination portion configured to determine an intermittent transmission cycle including a first period during which the synchronization signal is transmitted and a second period without transmission of the synchronization signal; and a transmission controller configured to control the transmitter so that the synchronization signal is transmitted in the first period except for the second period, each of the first and second eyeglass devices comprises: a second receiver configured to receive the synchronization signal; an optical filter portion configured to adjust a light amount from the video; and a controller configured to control the optical filter portion based on the synchronization signal received during the first period, the determination portions of the first and second display devices determine the transmission cycle based on the reference signal, the determination portion of the first display device adjusts and prevents a timing of the first period from overlapping with a timing of the first period determined by the determination portion of the second display device to avoid interference between the synchronization signals from the first and second display devices, the second receiver of the first eyeglass device receives the synchronization signal from the first display device, and the second receiver of the second eyeglass device receives the synchronization signal from the second display device.

### BRIEF DESCRIPTION OF THE DRAWINGS

FIG. 1 is a schematic view of a video system according to the first embodiment of the present invention.

FIG. 2 is a block diagram schematically showing a hardware configuration of the display device of the video system shown in FIG. 1.

FIG. 3 is a block diagram schematically shows a hardware configuration of a second processing circuit of the display device shown in FIG. 2.

FIG. 4 schematically shows shaping operation of a signal waveform in the second processing circuit shown in FIG. 3.

FIG. 5 is a block diagram schematically showing a functional configuration of the display device shown in FIG. 2.

FIG. 6 is a block diagram schematically showing a hardware configuration of an eyeglass device of the video system shown in FIG. 1.

FIG. 7 is a block diagram schematically showing a functional configuration of the eyeglass device shown in FIG. 6.

FIG. 8 is a schematic view depicting communication of synchronization signals performed by the display device shown in FIGS. 2 and 3.

FIG. 9 is a schematic view depicting transmission of synchronization signals by first and second display devices shown in FIG. 1.

FIG. 10 is a schematic view depicting timing adjustment of the first and/or second periods with the display device shown in FIGS. 2 and 3.

FIG. 11 is a schematic view depicting the timing adjustment of the first and/or second periods with the display device shown in FIGS. 2 and 3.

FIG. 12 is a schematic view depicting the timing adjustment of the first and/or second periods with the display device shown in FIGS. 2 and 3.

FIG. 13 is a block diagram schematically showing a functional configuration of a display device used in the second embodiment of the present invention.

FIG. 14 is a schematic view depicting transmission and reception of synchronization signals by the display device shown in FIG. 13.

FIG. 15 is a schematic view depicting timing adjustment of first and/or second periods with the display device shown in FIG. 13.

FIG. 16 is a schematic view depicting transmission and reception of the synchronization signals by the display device after the timing adjustment of the first and/or second periods shown in FIG. 15.

FIG. 17 is a schematic view of a video system according to the third embodiment of the present invention.

FIG. 18 is a block diagram schematically showing a hardware configuration of a display device of the video system shown in FIG. 17.

FIG. 19 is a block diagram schematically showing a functional configuration of the display device shown in FIG. 17.

FIG. 20 is a schematic view depicting a method for determining a transmission cycle with the display device shown in FIGS. 18 and 19.

FIG. 21 is a schematic view depicting timing adjustment of the first and/or second periods among three display devices.

### DESCRIPTION OF THE INVENTION

A display device and a video system according to one embodiment are described hereinafter with reference to the accompanying drawings. Configurations, arrangements and shapes shown in the drawings and the description relating to the drawings merely serve to facilitate understanding of principles of the display device and the video system without limiting their principles.

### First Embodiment

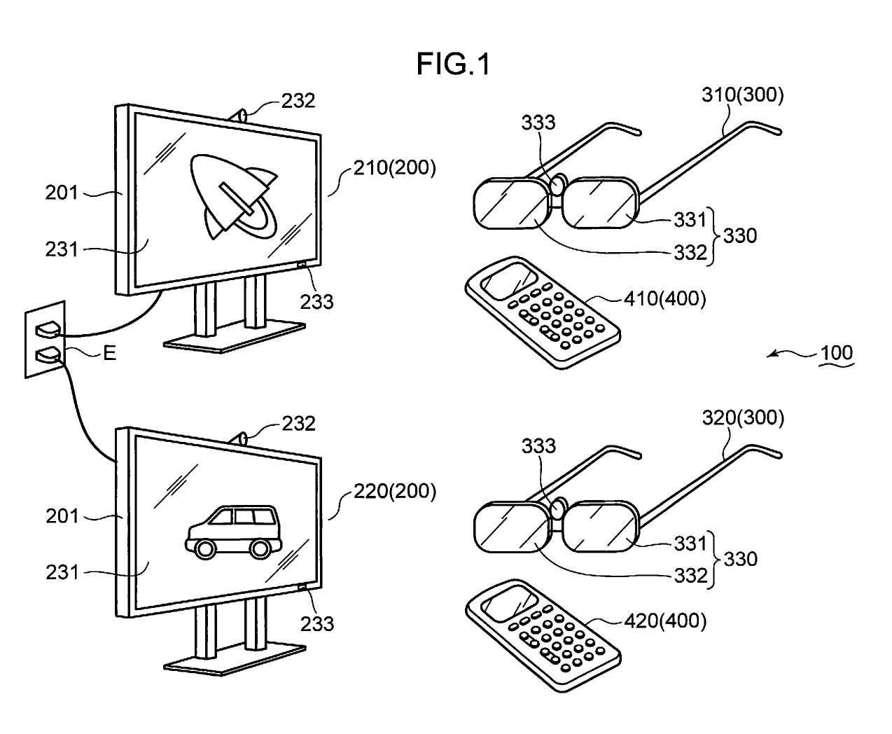

FIG. 1 schematically shows a video system. FIG. 1 merely clarifies principles of the video system. The video system according to the present embodiment is not limited in any way to detailed structures, arrangements and shapes shown in FIG. 1.

### Video System

The video system 100 is provided with a display device 200 configured to display a stereoscopic video, an eyeglass device 300 configured to perform stereoscopic view assistance for causing a viewer to stereoscopically perceive the video, and a remote controller 400 configured to operate the display device 200. In the present embodiment, the display device 200 means at least one of a first display device 210 and a second display device 220. The contents of the stereoscopic video displayed by the first display device 210 may be different from those of the stereoscopic video displayed by the second display device 220. In the present embodiment, the first display device 210 displays a stereoscopic video of “Rocket” while the second display device 220 displays a stereoscopic video of “Automobile”.

In the present embodiment, the eyeglass device 300 means at least one of a first eyeglass device 310 and a second eyeglass device 320. The first eyeglass device 310 is used to assist in viewing the video displayed by the first display device 210. The second eyeglass device 320 is used to assist in viewing the video displayed by the second display device 220.

In the present embodiment, the remote controller 400 means at least one of a first remote controller 410 and a second remote controller 420. The first remote controller 410 is used to transmit a control signal for causing the first display device 210 to perform a predetermined operation. The second remote controller 420 is used to transmit a control signal for causing the second display device 220 to perform a predetermined operation.

The display device 200 includes a display panel 231 configured to display the video to be stereoscopically perceived. For example, a CRT display, a liquid crystal display, a PDP (plasma display panel), an organic electroluminescence display, or other devices configured to display videos may be preferably used as the display panel 231. The video displayed on the display panel 231 includes a left frame image, which is created or depicted so as to be viewed by the left eye and a right frame image, which is created or depicted so as to be viewed by the right eye. In the present embodiment, the left and right frame images are alternately displayed on the display panel 231. In the present embodiment, display timings of the frame images of the first display device 210 may not be associated with display timings of frame images of the second display device 220.

The eyeglass device 300 executes the stereoscopic view assistance so that a viewer views the left frame image with the left eye and the right frame image with the right eye. As a result, the viewer three-dimensionally (stereoscopically) perceives the video displayed on the display panel 231. If the video is stereoscopically perceived, objects depicted in the left and right frame images (for example, “Rocket” displayed by the first display device 210 and “Automobile” displayed by the second display device 220) are perceived as protruded forward or pulled back from a flat screen of the display panel 231.

The display device 200 is provided with a housing 201, which surrounds the periphery of the display panel 231 and a transmission device 232 provided on the upper edge of the housing 201. The transmission device 232 is used as a transmitter configured to transmit synchronization signals in synchronism with displays of the left and right frame images on the display panel 231. For example, an IR light emitter, an RF transmitter or any other element configured to transmit synchronization signals may be preferably used as the transmission device 232.

The synchronization signal from the transmission device 232 is received by the eyeglass device 300. The synchronization signals are intermittently transmitted. The synchronization signals are transmitted during a predetermined length of a first period whereas the synchronization signals are not transmitted during a predetermined length of a second period following the first period. The first and second periods are alternately repeated to perform the intermittent transmission of the synchronization signal.

In the following descriptions, the synchronization signal transmitted from the first display device 210 is exemplified as the first synchronization signal. The synchronization signal transmitted from the second display device 220 is exemplified as the second synchronization signal. If the first and/or second periods are appropriately set between the first and second display devices 210, 220, the first synchronization signal is appropriately received by the first eyeglass device 310. The first eyeglass device 310 executes the aforementioned stereoscopic view assistance on the basis of the first synchronization signal. As a result, a viewer wearing the first eyeglass device 310 may view the left and right frame images displayed by the first display device 210 with the left and right eyes, respectively. The viewer wearing the first eyeglass device 310 may thus stereoscopically perceive the video displayed by the first display device 210. If the first and/or second periods are appropriately set between the first and second display devices 210, 220, the first synchronization signal is not received by the second eyeglass device 320. Alternatively, the second eyeglass device 320 may not operate on the basis of the first synchronization signal although the second eyeglass device 320 receives the first synchronization signal. As a result, a viewer wearing the second eyeglass device 320 may view a stereoscopic video displayed by the second display device 220 with little influence from the first synchronization signal.

Similarly, if the first and/or second periods are appropriately set between the first and second display devices 210, 220, the second synchronization signal is appropriately received by the second eyeglass device 320. The second eyeglass device 320 executes the aforementioned stereoscopic view assistance on the basis of the second synchronization signal. As a result, the viewer wearing the second eyeglass device 320 may view the left and right frame images displayed by the second display device 220 with the left and right eyes, respectively. The viewer wearing the second eyeglass device 320 may thus stereoscopically perceive the video displayed by the second display device 220. If the first and/or second periods are appropriately set between the first and second display devices 210, 220, the second synchronization signal is not received by the first eyeglass device 310. Alternatively, the first eyeglass device 310 may not operate on the basis of the second synchronization signal although the first eyeglass device 310 receives the second synchronization signal. As a result, the viewer wearing the first eyeglass device 310 may view the stereoscopic video displayed by the first display device 210 with little influence from the second synchronization signal.

Under inadequate settings of the first and/or second periods, the first eyeglass device 310 adjusts a light amount on the basis of the first and second synchronization signals. Similarly, under inadequate settings of the first and/or second periods, the second eyeglass device 320 adjusts a light amount on the basis of the first and second synchronization signals. As a result, the second synchronization signal may make a viewer wearing the first eyeglass device 310, for example, view the left and right frame images displayed by the first display device 210 with right and left eyes, respectively. Similarly, the first synchronization signal may make a viewer wearing the second eyeglass device 320, for example, view the left and right frame images displayed by the second display device 220 with the right and left eyes, respectively. As described later, the first and/or second periods are adjusted between the first and second display devices 210, 220 so as to avoid such interference between synchronization signals.

The display device 200 is provided with a first reception device 233, which receives control signals from the remote controller 400. In the present embodiment, the remote controller 400 is used for setting and adjusting the first and/or second periods. The setting and adjustment for the first and/or second periods by the remote controller 400 makes it less likely to cause the synchronization signal interference between the first and second display devices 210, 220. Therefore, in the present embodiment, the control signal from the remote controller 400 is used as the external signal for adjusting the timings of the first and/or second periods. The first reception device 233 is used as the first receiver configured to receive the external signal for adjusting the timings of the first and/or second periods.

In the present embodiment, the first and second display devices 210, 220 receive power from a common commercial power source E. The AC voltage from the commercial power source E is used as a reference signal for adjusting the first and/or second periods between the first and second display devices 210, 220.

The eyeglass device 300 looks like eyeglasses for vision correction. The eyeglass device 300 is provided with an optical filter portion 330 including a left filter 331 situated in front of the left eye of a viewer wearing the eyeglass device 300 and a right filter 332 situated in front of the right eye. The left and right filters 331, 332 are optical elements configured to adjust a light amount transmitted to the left and right eyes of the viewer. Therefore, shutter elements (for example, liquid crystal shutters) which open and close a optical path along which the light is transmitted to the left and right eyes of the viewer, deflection elements (for example, liquid crystal filters) which deflect the light transmitted to the left and right eyes of the viewer, or other optical elements configured to adjust the light amount may be used as the left and right filters 331, 332.

If the first and/or second periods are appropriately set between the first and second display devices 210, 220, the left filter 331 of the first eyeglass device 310 allows light to be transmitted to the left eye of the viewer whereas the right filter 332 of the first eyeglass device 310 inhibits the light transmission to the right eye of the viewer while the first display device 210 displays the left frame image. The viewer thus may view the left frame image with the left eye. While the first display device 210 displays the right frame image, the right filter 332 of the first eyeglass device 310 allows light to be transmitted to the right eye of the viewer whereas the left filter 331 of the first eyeglass device 310 inhibits the light transmission to the left eye of the viewer. The viewer thus may view the right frame image with the right eye. By means of such stereoscopic view assistance, the viewer wearing the first eyeglass device 310 may stereoscopically perceive the video displayed by the first display device 210.

Similarly, if the first and/or second periods are appropriately set between the first and second display devices 210, 220, the left filter 331 of the second eyeglass device 320 allows the light to be transmitted to the left eye of the viewer whereas the right filter 332 of the second eyeglass device 320 inhibits the light transmission to the right eye of the viewer while the second display device 220 displays the left frame image. The viewer thus may view the left frame image with the left eye. While the second display device 220 displays the right frame image, the right filter 332 of the second eyeglass device 320 allows the light to be transmitted to the right eye of the viewer whereas the left filter 331 of the second eyeglass device 320 inhibits the light transmission to the left eye of the viewer. The viewer thus may view the right frame image with the right eye. By means of such stereoscopic view assistance, the viewer wearing the second eyeglass device 320 may stereoscopically perceive the video displayed by the second display device 220.

The eyeglass device 300 includes a second reception device 333 provided between the left and right filters 331, 332. The second reception device 333 is used as the second receiver, which receives a synchronization signal transmitted in synchronism with the display of the video frame image. The second reception device 333 receives the synchronization signal from the transmission device 232 to achieve the aforementioned synchronization between the video frame image and the stereoscopic view assistance of the optical filter portion 330. If an IR light emitter is used as the transmission device 232, an IR reception device may be preferably used as the second reception device 333. If an RF transmitter is used as the transmission device 232, an RF receiver may be preferably used as the second reception device 333. Alternatively, any device configured to receive synchronization signals transmitted by the transmission device 232 may be used as the second reception device 333.

### Display Device

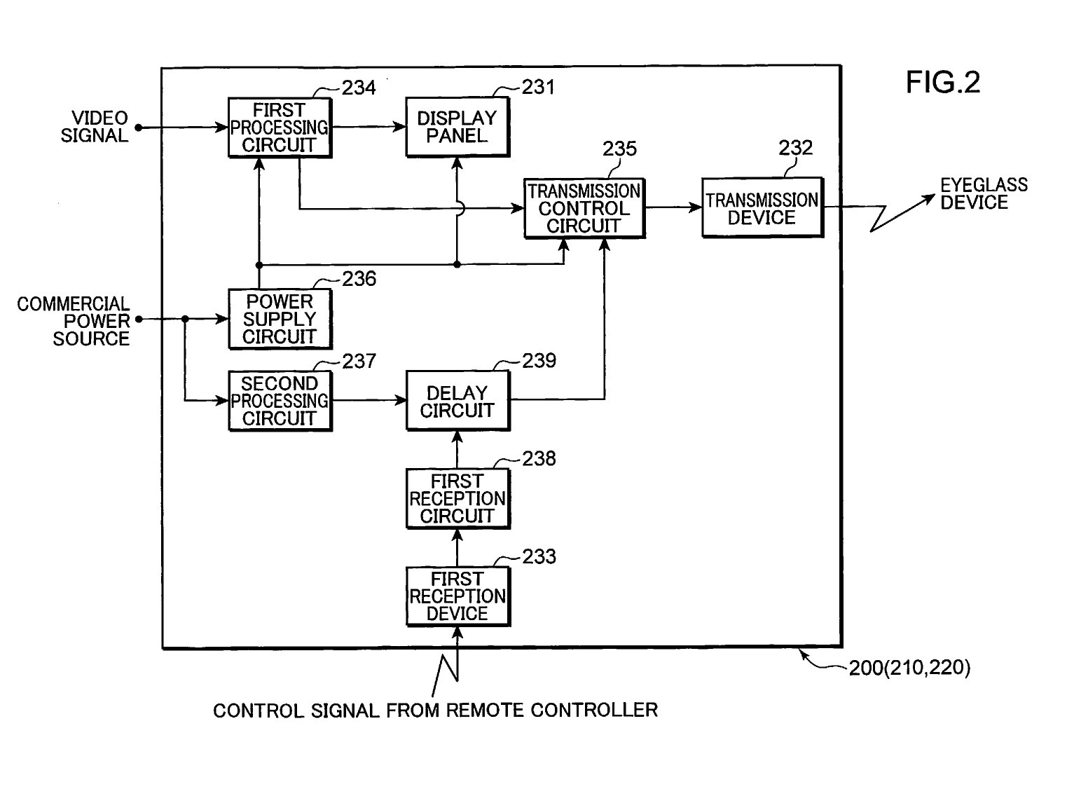

FIG. 2 is a block diagram schematically showing a hardware configuration of the display device 200. The display device 200 is described hereinafter with reference to FIGS. 1 and 2. The first and second display devices 210, 220 have similar hardware configurations.

The display device 200 is provided with a first processing circuit 234, a display panel 231, a transmission control circuit 235, the transmission device 232, a power supply circuit 236, a second processing circuit 237, the first reception device 233, a first reception circuit 238, and a delay circuit 239.

An encoded video signal is input to the first processing circuit 234 of the display device 200. The first processing circuit 234 decodes the video signal. MPEG (Motion Picture Experts Group)-2, MPEG-4 and H264 are exemplified as encoding methodologies of video signals.

The first processing circuit 234 further performs signal processes relating to display of stereoscopic videos. The first processing circuit 234 processes video signals to output decoded video data as video signals for displaying a stereoscopic video. Alternatively, the first processing circuit 234 may detect video signals for the left eye, which serve to display the left frame image, and video signals for the right eye, which serve to display the right frame image, from the decoded video data. The detected video signals for the left and right eyes are alternately displayed on the display panel 231 as the left and right frame images, respectively. Alternatively, the video signals for the left eye, which serve to display the left frame image and the video signals for the right eye that serve to display the right frame image may be automatically generated from the decoded video data, and then the first processing circuit 234 may alternately output the generated video signals for the left and right eyes to the display panel 231. After the signal processes relating to the display of the stereoscopic videos, the first processing circuit 234 generates output signals, which matches to signal input methods of the display panel 231.

The video signals (left and right frame images) output from the first processing circuit 234 are displayed on the display panel 231. A viewer wearing the eyeglass device 300 stereoscopically perceives the frame images displayed on the display panel 231 under the stereoscopic view assistance of the eyeglass device 300.

The first processing circuit 234 further generates synchronization signals, which is synchronized with at least one of displays of the left and right frame images. The generated synchronization signal is output to the transmission control circuit 235.

The first processing circuit 234 may also execute processes other than the aforementioned processes. For example, the first processing circuit 234 may perform processes to adjust colors of the displayed video or may interpolate images between the frame images of the decoded video data according to characteristics of the display panel 231 to increase a frame rate of the video.

The transmission control circuit 235 controls a transmission timing of the synchronization signal generated by the first processing circuit 234 to achieve the intermittent transmission of the synchronization signals. The transmission control circuit 235 outputs the synchronization signal to the transmission device 232 during the aforementioned first period. As a result, in the first period, the transmission device 232 transmits the synchronization signal to the eyeglass device 300 as described above. The transmission control circuit 235 does not output the synchronization signal to the transmission device 232 during the aforementioned second period. As a result, in the second period, the transmission device 232 stops the transmission of the synchronization signal. The timings of the first and/or second periods are adjusted by the delay circuit 239.

The transmission device 232 transmits the synchronization signal to the eyeglass device 300 under control by the transmission control circuit 235. As described above, the eyeglass device 300 executes the stereoscopic view assistance of the optical filter portion 330 on the basis of the synchronization signal.

The power supply circuit 236 converts the AC power from the commercial power source E into DC power, and then supplies the power to each element (for example, the first processing circuit 234, display panel 231, and transmission control circuit 235) constituting the display device 200.

The AC voltage from the commercial power source E is branched prior to the input to the power supply circuit 236 so that the AC voltage is input to the second processing circuit 237 as well. The second processing circuit 237 converts waveform of the AC voltage from the commercial power source E into a waveform to be readable with the delay circuit 239.

The first reception device 233 receives a control signal from the remote controller 400 as described above. The control signal from the remote controller 400 includes a signal for adjusting the timings of the first and/or second periods as well as various signals necessary for causing the display device 200 to perform various operations.

The first reception circuit 238 analyzes information included in the control signal from the remote controller 400. Based on the analysis results, the first reception circuit 238 outputs the control signal from the remote controller 400 to constituent elements of the display device 200, respectively. As a result, the display device 200 performs operations desired by the viewer.

If it is determined that the control signal from the remote controller 400 is a signal for adjusting the timings of the first and/or second periods as a result of the analysis performed by the first reception circuit 238, the first reception circuit 238 outputs the control signal from the remote controller 400 to the delay circuit 239.

The delay circuit 239 determines the start and/or end timings of the first period (and/or, the start and/or end timings of the second period) in response to signals which has been subjected to processes in the second processing circuit 237 (to be referred to hereinafter as “processed signal”) and the control signal from the remote controller 400. The delay circuit 239 outputs information on the timings of the first and/or second periods to the transmission control circuit 235.

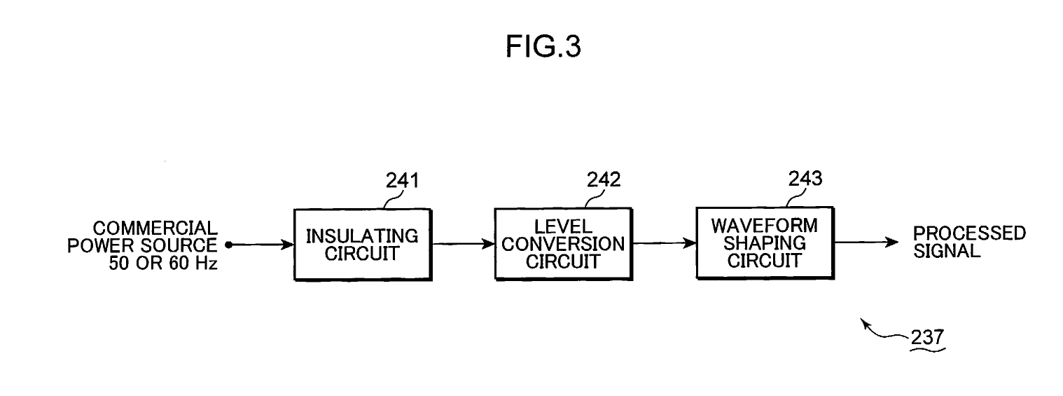

FIG. 3 schematically shows a hardware configuration of the second processing circuit 237. The hardware configuration of the second processing circuit 237 is described hereinafter with reference to FIG. 3.

The second processing circuit 237 is provided with an insulating circuit 241, a level conversion circuit 242, and a waveform shaping circuit 243. The insulating circuit 241 insulates the AC voltage (for example, 100 V) supplied from the commercial power source E. The level conversion circuit 242 takes in the insulated AC voltage as a sine voltage signal at several volts. The waveform shaping circuit 243 is used as a waveform shaper, which shapes the sine voltage signal generated by the level conversion circuit into a rectangular signal. The second processing circuit 237 may be, for example, an element such as an insulated transformer or a photocoupler.

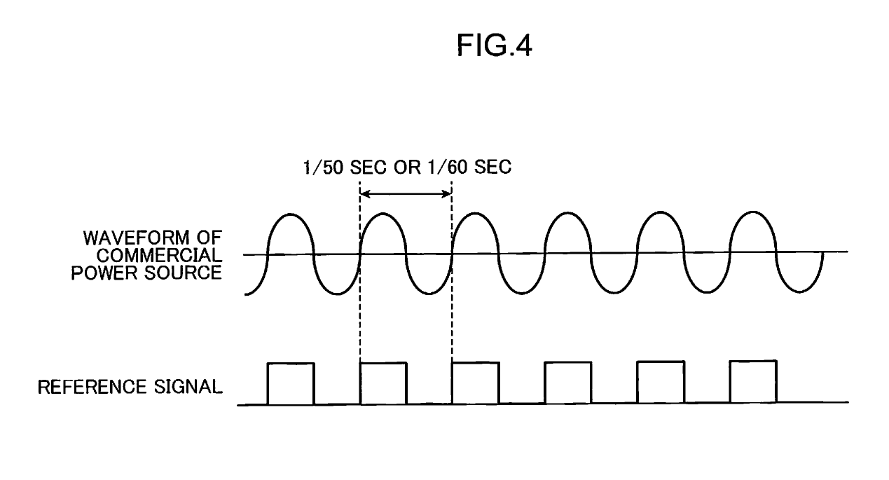

FIG. 4 schematically shows a relationship between the AC voltage waveform from the commercial power source E and the processed signal, which is generated by the second processing circuit 237. The relationship between the AC voltage waveform and the processed signal is described hereinafter with reference to FIGS. 3 and 4.

The period of the AC voltage from the commercial power source E is typically 1/50 sec or 1/60 sec. The second processing circuit 237 generates a processed signal with a period (frequency), which is substantially equal to that of the AC voltage.

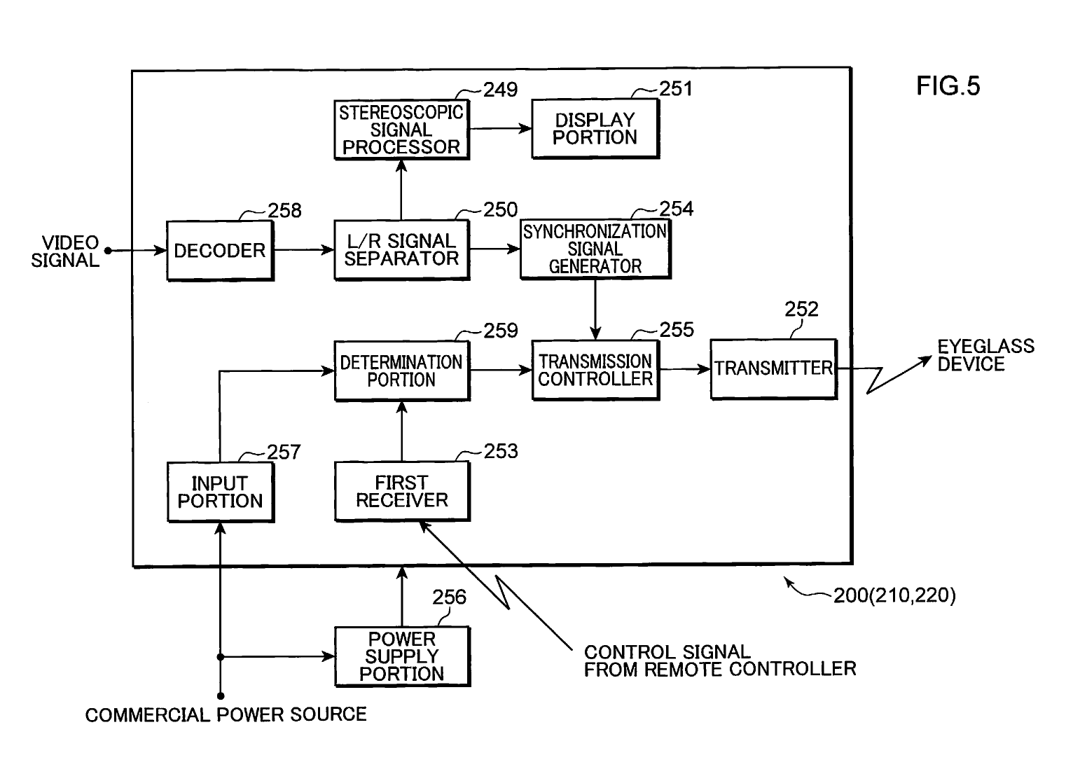

FIG. 5 is a block-diagram schematically showing a functional configuration of the display device 200. The display device 200 is further described hereinafter with reference to FIGS. 1 to 5.

The display device 200 is provided with a decoder 258, an L/R signal separator 250, a stereoscopic signal processor 249, a display portion 251, a synchronization signal generator 254, a transmission controller 255, a transmitter 252, a first receiver 253, a power supply portion 256, an input portion 257, and a determination portion 259.

An encoded video signal is input to the decoder 258. The decoder 258 decodes the input video signal.

The L/R signal separator 250 generates or separates video signals (left and right frame images) for the left and right eyes from the video signal decoded by the decoder 258.

The stereoscopic signal processor 249 adjusts the video signals for the left and right eyes separated by the L/R signal separator 250 according to characteristics of the display portion 251, which displays the video to be viewed through the eyeglass device 300. For example, the stereoscopic signal processor 249 executes processes to adjust a parallax amount between the left and right frame images according to a display screen size of the display portion 251. The display portion 251 corresponds to the exemplary display panel 231 shown in FIG. 1.

The synchronization signal generator 254 generates a synchronization signal, which is synchronized with or corresponded to the left and right frame images generated by the L/R signal separator 250. Meanwhile, types of the generated synchronization signals (for example, the waveforms thereof) or generation timings may be adjusted according to characteristics of the display portion 251.

In the hardware configuration described in the context of FIG. 2, the decoder 258, L/R signal separator 250, stereoscopic signal processor 249, and synchronization signal generator 254 correspond to the first processing circuit 234.

The display portion 251 displays video signals processed by the stereoscopic signal processor 249 as a video. As described above, in the hardware configuration described in the context of FIG. 2, the display portion 251 corresponds to the display panel 231.

The power supply portion 256 converts the AC power from the commercial power source E to DC power, and then supplies the power to various elements (for example, the decoder 258, L/R signal separator 250, stereoscopic signal processor 249, display portion 251, synchronization signal generator 254, and transmission controller 255) constituting the display device 200. In the hardware configuration described in the context of FIG. 2, the power supply portion 256 corresponds to the power supply circuit 236.

In the present embodiment, the AC voltage from the commercial power source E used as a reference signal is branched prior to the input to the power supply portion 256 so that the AC voltage is input to the input portion 257 as well. As described above with reference to FIGS. 3 and 4, the input portion 257 generates a processed signal on the basis of the AC voltage from the commercial power source E, so that the determination portion 259 may read a frequency or phase of the AC voltage by the cycle of the AC voltage. In the hardware configuration described in the context of FIG. 2, the input portion 257 corresponds to the second processing circuit 237.

The first receiver 253 receives the control signal from the remote controller 400 and outputs information, which is related to the timings of the first and/or second periods and included in the control signal from the remoter controller 400, to the determination portion 259. In the hardware configuration described in the context of FIG. 2, the first receiver 253 corresponds to the first reception device 233 and the first reception circuit 238.

The determination portion 259 determines start and/or end timings of the first period (and/or, the start and/or end timings of the second period) in response to the processed signal from the input portion 257 and the control signal from the remote controller 400 to define intermittent transmission of the synchronization signals. The determination portion 259 outputs information on the timings of the first and/or second periods to the transmission controller 255. In the hardware configuration described in the context of FIG. 2, the determination portion 259 corresponds to the delay circuit 239.

The transmission controller 255 controls the transmitter 252 to effect the intermittent transmission of synchronization signals. The transmission controller 255 outputs the synchronization signal to the transmitter 252 during the first period determined by the determination portion 259. As a result, during the first period, the transmitter 252 transmits the synchronization signal in synchronism with the display of the frame image by the display portion 251 to the eyeglass device 300. The transmission controller 255 does not output the synchronization signal to the transmitter 252 during the second period. As a result, during the second period, the transmitter 252 stops the transmission of the synchronization signal. The timings of the first and/or second periods are adjusted by the determination portion 259. In the hardware configuration described in the context of FIG. 2, the transmission controller 255 corresponds to the transmission control circuit 235.

The transmitter 252 transmits the synchronization signal generated by the synchronization signal generator 254 to the eyeglass device 300 under the control performed by the transmission controller 255. In the hardware configuration described in the context of FIG. 2, the transmitter 252 corresponds to the transmission device 232.

### Eyeglass Device

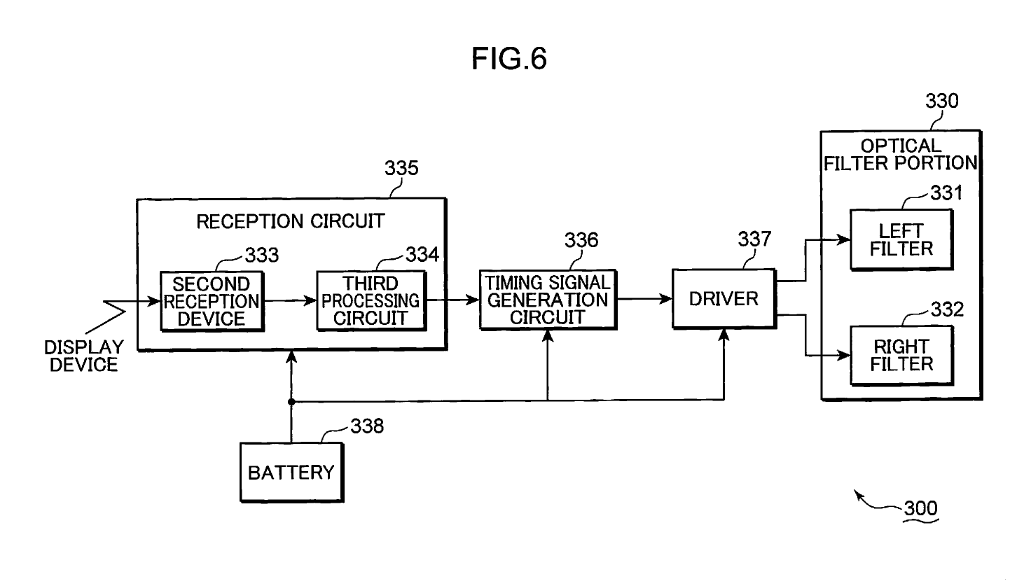

FIG. 6 is a block diagram schematically showing a hardware configuration of the eyeglass device 300. The eyeglass device 300 is described hereinafter with reference to FIGS. 1 and 6.

The eyeglass device 300 is provided with a battery 338, a reception circuit 335, a timing signal generation circuit 336, a driver 337, and an optical filter portion 330.

The battery 338 is used as a power source of the eyeglass device 300. The reception circuit 335, timing signal generation circuit 336, and driver 337 receive power supply from the battery 338.

The reception circuit 335 includes a second reception device 333 and a third processing circuit 334. The second reception device 333 receives a synchronization signal transmitted from the display device 200. The third processing circuit 334 outputs the synchronization signal received by the second reception device 333 as a predetermined electric signal to the timing signal generation circuit 336.

The timing signal generation circuit 336 generates a timing signal in response to the electric signal output from the reception circuit 335. The timing signal is generated so as to be synchronized with the synchronization signal received by the second reception device 333. The generated timing signal is output to the driver 337.

The driver 337 controls the optical filter portion 330 in response to the timing signal. As a result, while the display portion 251 displays the left frame image, the left filter 331 allowed an increased light amount from the left frame image to reach the left eye of the viewer whereas little light from the left frame image is allowed by the right filter 332 to reach the right eye of the viewer. If the display portion 251 displays the right frame image, the right filter 332 allows an increased light amount from the right frame image to reach the right eye of the viewer whereas the left filter 331 allows little light from the right frame image to reach the left eye of the viewer.

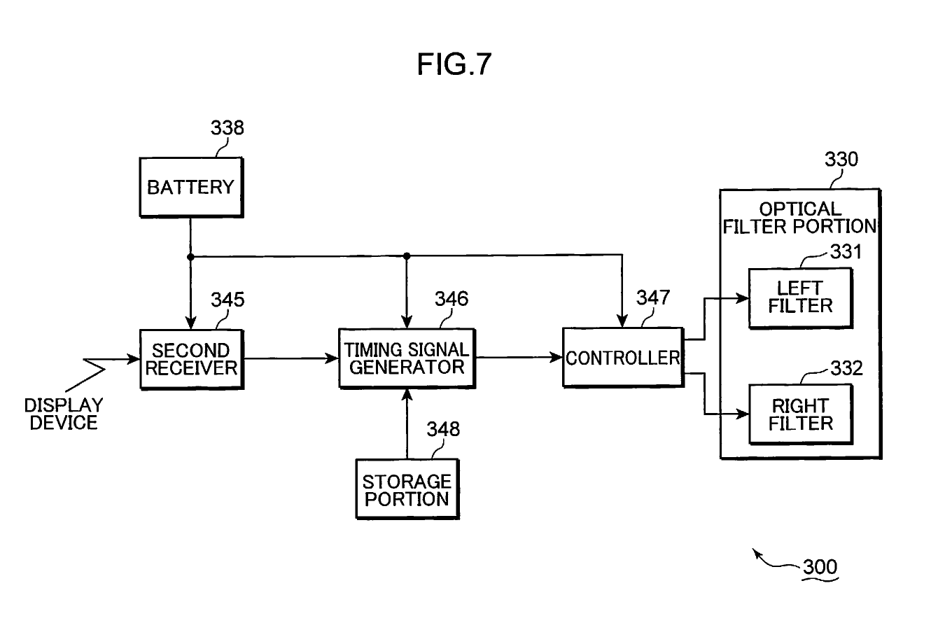

FIG. 7 is a block diagram schematically showing a functional configuration of the eyeglass device 300. The eyeglass device 300 is further described hereinafter with reference to FIGS. 1, 6 and 7.

The eyeglass device 300 is provided with the battery 338, a second receiver 345, a timing signal generator 346, a controller 347, a storage portion 348 and the optical filter portion 330.

The battery 338 is used as a power source of the eyeglass device 300. The second receiver 345, timing signal generator 346 and controller 347 receive power supply from the battery 338.

The second receiver 345 receives a synchronization signal transmitted from the display device 200. The second receiver 345 converts the received synchronization signal into a predetermined electric signal and outputs the electric signal to the timing signal generator 346. The second receiver 345 corresponds to the reception circuit 335 described in the context of FIG. 6.

The storage portion 348 stores in advance information relating to lengths of the first and/or second periods. The timing signal generator 346 reads out the information relating to the lengths of the first and/or second periods stored in the storage portion 348. The timing signal generator 346 generates a timing signal, for example, in response to the synchronization signal, which has received during a period from the initial reception of the synchronization signal in the first period until an equivalent time period to the first period stored in the storage portion 348 passes. The timing signal generator 346 ignores the synchronization signal received by the second receiver 345 during a period from when the equivalent time period to the first period passes to when an equivalent time to the second period stored in the storage portion 348 passes. The timing signal generator 346 therefore continues generating the timing signals during the second period on the basis of the synchronization signals received during the first period.

The controller 347 controls the optical filter portion 330 in response to the timing signal. As a result, while the display portion 251 displays the left frame image, the left filter 331 allows an increased light amount from the left frame image to reach the left eye of the viewer whereas little light is allowed by the right filter 332 to reach the right eye of the viewer. While the display portion 251 displays the right frame image, an increased light amount from the right frame image is allowed by the right filter 332 to reach the right eye of the viewer whereas the left filter 331 allows little light from the right frame image to reach the left eye of the viewer.

### Communication of Synchronization Signals

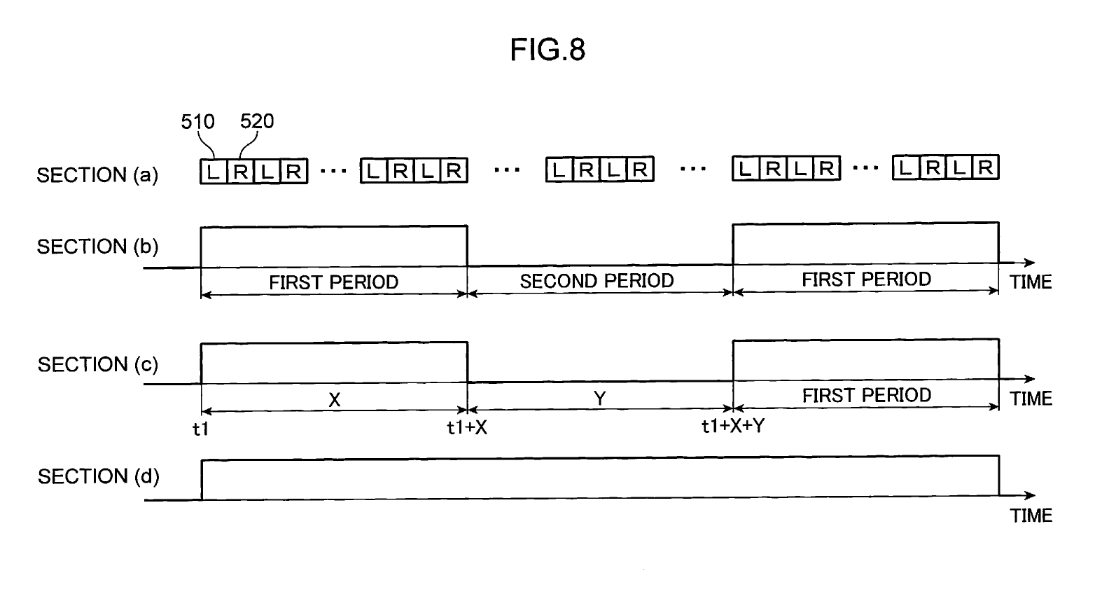

FIG. 8 is a schematic view depicting communication of synchronization signals. Section (a) in FIG. 8 shows a frame image displayed by the display portion 251. Section (b) in FIG. 8 shows transmission of a synchronization signal from the transmitter 252. Section (c) in FIG. 8 shows reception of the synchronization signal by the second receiver 345. Section (d) in FIG. 8 shows generation of a timing signal by the timing signal generator 346. Communication of synchronization signals is described with reference to FIGS. 1, 5, 7 and 8.

As shown in section (a) in FIG. 8, the display portion 251 alternately displays left and right frame images 510, 520. The transmitter 252 transmits synchronization signals in synchronism with displays of the left and/or right frame images 510, 520 during the first period under control by the transmission controller 255. The waveform of the synchronization signal, which is synchronized with the display of the left frame image 510, is preferably different from the waveform of the synchronization signal, which is synchronized with the display of the right frame image 520. The second receiver 345 receives the synchronization signals during the first period whereas the second receiver 345 does not receive synchronization signals during the second period.

The storage portion 348 stores in advance data “X” relating to a length of the first period and data “Y” relating to a length of the second period. The timing signal generator 346 measures or analyzes a reception interval or waveforms of the synchronization signals received during a period from the reception timing “t1” of the initial synchronization signal received during the first period to the timing “t1+X”. The timing signal generator 346 identifies the synchronization signals, which are synchronized with the display of the left frame image 510 and the synchronization signals, which are synchronized with the display of the right frame image 520, on the basis of the waveform of the synchronization signals. The reception interval of the synchronization signals, which are synchronized with the display of the left frame image 510, is also calculated. Similarly, the reception interval of the synchronization signals, which are synchronized with the display of the right frame image 520, is calculated.

In the first period, the timing signal generator 346 generates timing signals to be used for driving the left and right filters 331, 332 in synchronism with the reception of the synchronization signals. In the second period, the timing signal generator 346 adds a value of integer multiple of the calculated reception interval of the synchronization signal to the reception timing of the last synchronization signal among the synchronization signals received in the first period. The timing signal generator 346 generates a timing signal, which is synchronized with the display of the left frame image 510 during the second period, at a timing obtained by adding the value of integer multiple of the calculated reception interval of the synchronization signal to the reception timing of the synchronization signal, which is synchronized with the latest displayed left frame image 510 in the first period. The generated timing signal is used to drive the left filter 331. Similarly, in the first period, the timing signal generator 346 generates a timing signal, which is synchronized with the display of the right frame image 520 during the second period, at a timing obtained by adding the value of integer multiple of the calculated reception interval of the synchronization signal to the reception timing of the synchronization signal which is synchronized with the latest displayed right frame image 520. The generated timing signal is used to drive the right filter 332. The optical filter portion 330 is thus appropriately controlled through the first period in which the synchronization signals are received and the second period without reception of the synchronization signals.

If the first eyeglass device 310 receives a synchronization signal from the second display device 220 in the second period (i.e. in the period from the timing “t1+X” to the timing “t1+X+Y”), the timing signal generator 346 of the first eyeglass device 310 ignores the reception of the synchronization signal. Thus, it becomes less likely that the first eyeglass device 310 is affected by the synchronization signal from the second display device 220 in the second period, so that the first eyeglass device 310 may appropriately continue the stereoscopic view assistance. Similarly, if the second eyeglass device 320 receives a synchronization signal from the first display device 210 in the second period, the timing signal generator 346 of the second eyeglass device 320 ignores the reception of the synchronization signal. Thus, it becomes less likely that the second eyeglass device 320 is affected by the synchronization signal from the first display device 210 in the second period, so that the second eyeglass device 320 may appropriately continue the stereoscopic view assistance.

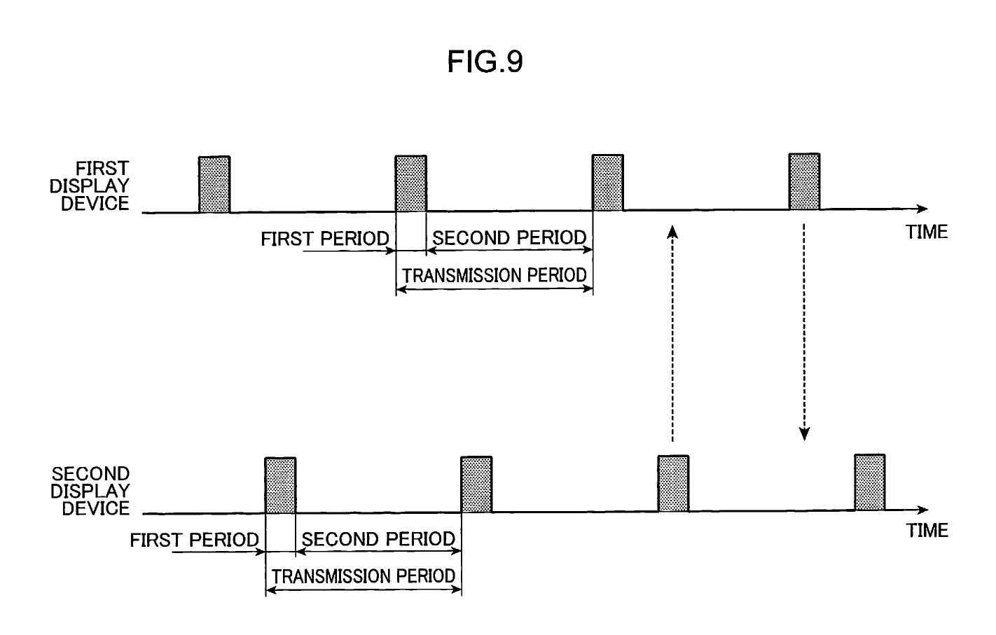

FIG. 9 schematically shows the transmissions of the synchronization signals of the first and second display devices 210, 220. The transmissions of the synchronization signals are described with reference to FIGS. 1, 5 and 9.

As described above, the determination portion 259 of the display device 200 determines the intermittent transmission cycle including the first period in which the synchronization signal is transmitted and the second period in which the synchronization signal is not transmitted. The determination portion 259 of the first display device 210 determines the first period so as not to overlap with the first period of the second display device 220. As a result, the first period determined by the first display device 210 is set in the second period of the second display device 220. As described above, the second eyeglass device 320 which assists in viewing the video displayed by the second display device 220 appropriately continues the stereoscopic view assistance with little influence from the synchronization signal, which is received from the first display device 210 in the second period.

Similarly, the determination portion 259 of the second display device 220 determines the first period so as not to overlap the first period of the first display device 210. As a result, the first period determined by the second display device 220 is set in the second period of the first display device 210. As described above, the first eyeglass device 310 which assists in viewing the video displayed by the first display device 210 appropriately continues the stereoscopic view assistance with little influence from the synchronization signal, which is received from the second display device 220 in the second period. As shown in FIG. 9, the determination portion 259 determines the first and/or second periods so as to avoid interference between the synchronization signals from the first and second display devices 210, 220.

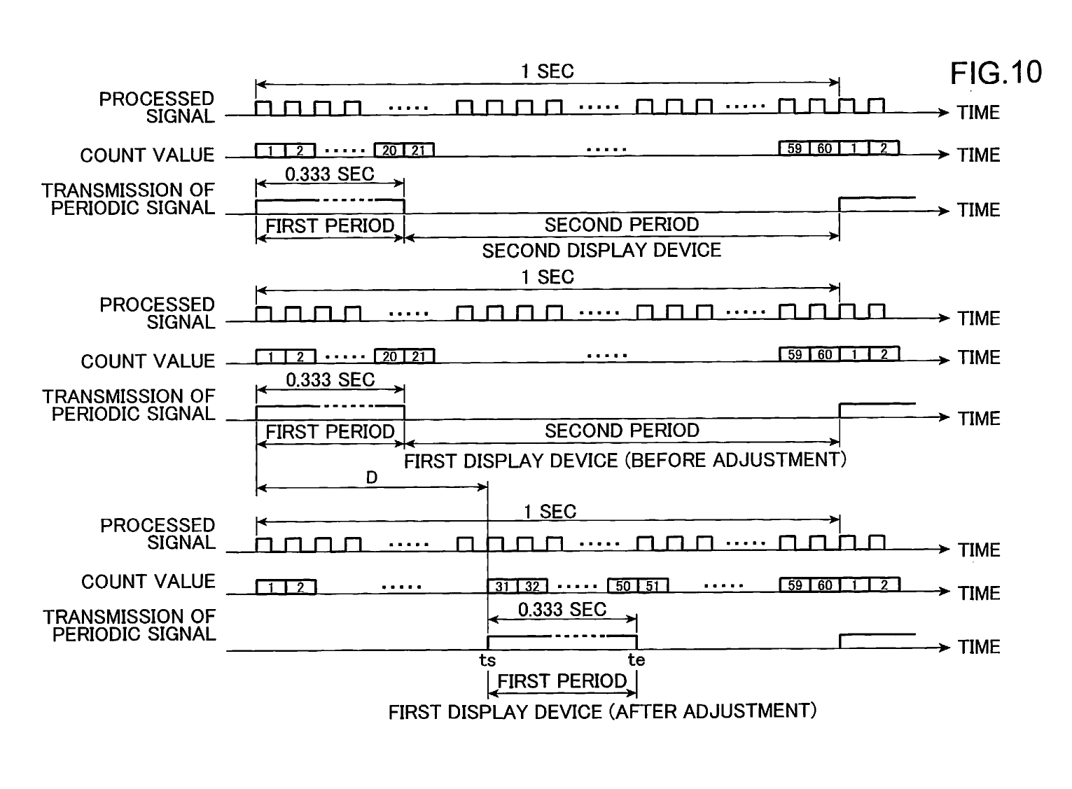

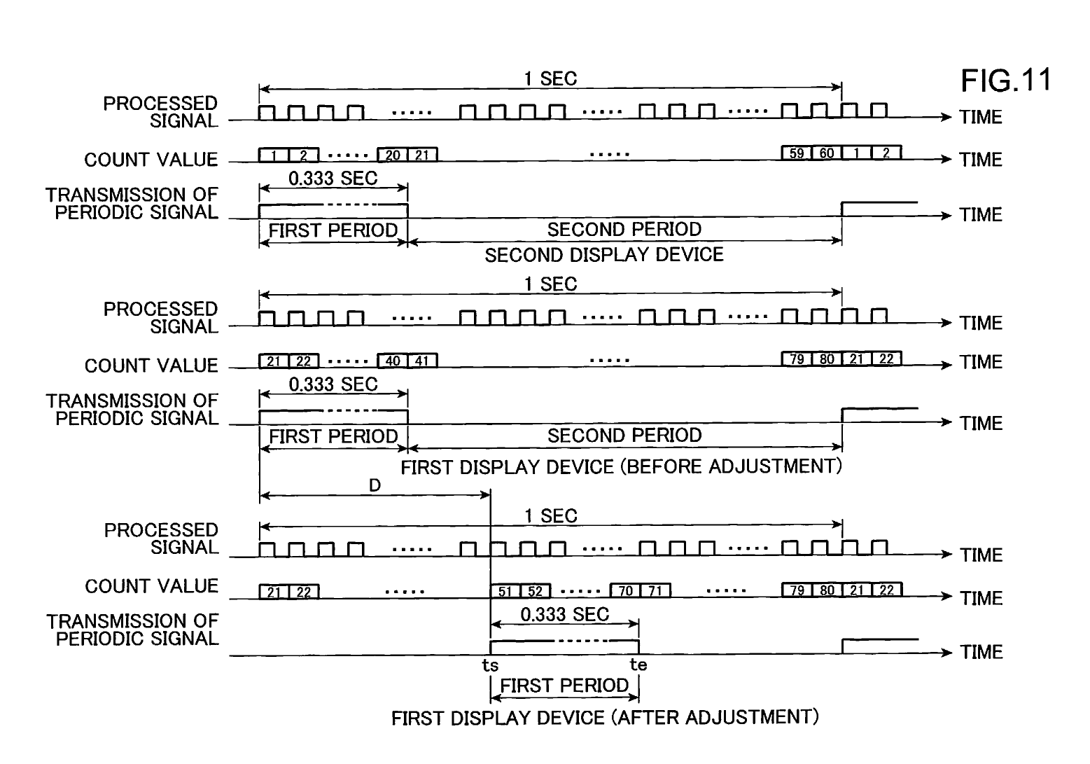

FIGS. 10 and 11 schematically show timing adjustments of the first and/or second periods. The timing adjustments of the first and/or second periods are described hereinafter with reference to FIGS. 1 and 5, and FIGS. 9 to 11.

As shown in FIGS. 10 and 11, the timings of the first and/or second periods of the first display device 210 is adjusted with reference to the second display device 220. Before the timings of the first and/or second periods of the first display device 210 is adjusted, the first period set in the first display device 210 overlaps with the first period set in the second display device 220.

The first and second display devices 210, 220 use the AC voltage (60 Hz) from the common commercial power source E as the reference signal. Therefore, the common reference signal is input to the input portions 257 of the first and second display devices 210, 220. As a result, a phase and frequency of the processed signal output by the input portion 257 of the first display device 210 are substantially equal to a phase and period of the processed signal output by the input portion 257 of the second display device 220.

The determination portion 259 allocates a count value to one cycle of the processed signal. In the present embodiment, the determination portion 259 handles a group of the processed signal cycles generated in 1 sec as one group. It should be noted that different count values are allocated to the groups of the processed signal cycles, respectively. Therefore, 60 count values are allocated to the processed signals generated in 1 sec. In FIG. 10, the same count values are allocated to processed signal cycles, which exists at substantially the same phase, between the first and second display devices 210, 220. On the other hand, as shown in FIG. 11, different count values may be also allocated to the processed signal cycles, which exists at substantially the same phase between the first and second display devices 210, 220. The second display device 220 shown in FIG. 11 uses count values from “1”to “60” whereas the first display device 210 shown in FIG. 11 uses count values from “21” to “80”. The total number of the count values used by the first display device 210 is set in advance to be equal to that used by the second display device 220. The total number of the count values defines the intermittent transmission cycle, which is described above in the context of FIG. 9. If the first and second display devices 210, 220 use and allocate mutually equal count values to the cycles of the processed signals generated on the basis of the common reference signal, the first and second display devices 210, 220 may transmit the synchronization signals in mutually equal transmission cycles.

The determination portion 259 of the second display device 220 determines a period from the count value “1” to the count value “20” as the first period. The determination portion 259 of the second display device 220 further determines a period from the count value “21” to the count value “60” as the second period. The determination portion 259 of the first display device 210 before the adjustment shown in FIG. 10 similarly determines a period from the count value “1” to the count value “20” as the first period and a period from the count value “21” to the count value “60” as the second period. The determination portion 259 of the first display device 210 before the adjustment shown in FIG. 11 determines a period from the count value “21” to the count value “40” as the first period and the remaining period (from the count value “41” to the count value “20”) as the second period.

Before the timing adjustments of the first and/or second periods, the first period set in the first display device 210 overlaps with the first period set in the second display device 220. Therefore, operation of the first eyeglass device 310 is affected not only by the synchronization signal from the first display device 210, but also by the synchronization signal from the second display device 220. As a result, a viewer wearing the first eyeglass device 310 to view a video displayed by the first display device 210 may not stereoscopically perceive the video. The viewer thus may recognize that there is interference between the first and second display devices 210, 220.

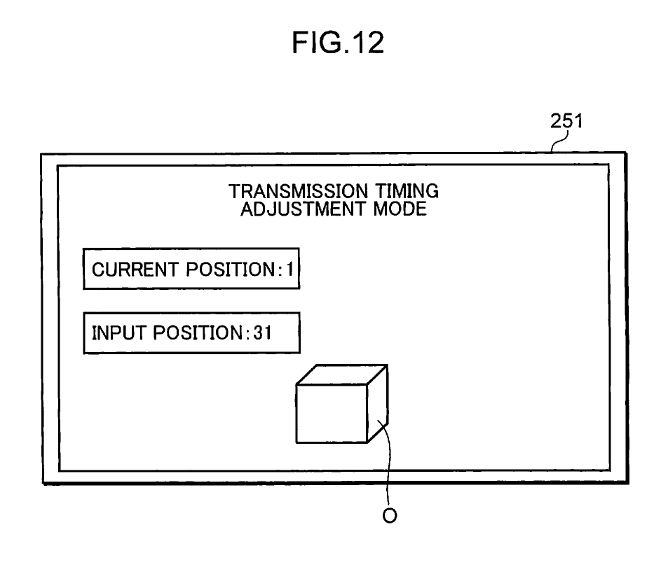

FIG. 12 shows an exemplary image for adjusting the timings of the first and/or second periods displayed on the display portion 251. The timing adjustments of the first and/or second periods are further described with reference to FIGS. 1 and 5, and FIGS. 10 to 12.

The display portion 251 displays, for example, the count value at the start of the first period at the current position. A viewer may use the remote controller to input a desired count value with reference to the current position displayed on the display portion 251. As shown in FIG. 12, an object O which is depicted or created to be stereoscopically perceived may be displayed on an adjustment mode screen. The viewer continues the input of the count values until the viewer may stereoscopically perceive the object O (i.e. until the interference between synchronization signals is eliminated).

In the adjustment of the first period shown in FIGS. 10 and 12, the viewer uses the first remote controller 410 to input a count value “31”. The first receiver 253 receives a control signal including information on the count value “31” from the first remote controller 410 and outputs the information to the determination portion 259. The determination portion 259 executes, for example, calculation for a difference between the count value “1” shown as the current position before the adjustment and the input count value “31”. The determination portion 259 then multiplies the calculated differential value by the inverse number of the total number of the count values allocated per 1 sec (in the adjustment depicted in FIGS. 10 and 12, this value is “60”) to calculate a delay time D. The determination portion 259 then determines a timing delayed by the delay time D with respect to the start timing of the first period before the adjustment as a start timing ts of the first period after the adjustment. In the present embodiment, the length of the first period is set in advance to a value of “0.333 sec”. The determination portion 259 adds “0.333 sec” to the determined start timing ts of the first period and determines the obtained value as the end timing ts of the first period. The first period of the first display device 210 is thus appropriately set within the second period, which has been set in the second display device 220 (i.e. the determination portion 259 of the first display device 210 sets and prevents the timing of the first period from overlapping with the first period which has been determined by the determination portion 259 of the second display device 220). If the timing of the first period is delayed by means of the count value by the cycle of the processed signal generated on the basis of the common reference signal, it becomes less likely that the first display device 210 causes interference with the synchronization signal transmitted from the second display device 220. The first display device 210 shown in FIG. 11 may also appropriately adjust the timing of the first period by similar methodologies.

In the present embodiment, the differential value “30” is calculated from the input count value “31”, and then the delay time D corresponding to the differential value is calculated. The start timing ts of the first period after the adjustment is then calculated on the basis of the calculated delay time D. The start timing ts may be also calculated by another method. For example, the abovementioned differential value “30” between count values before and after the adjustment is added to the count value “21” corresponding to the start timing of the first period before the adjustment. The resultant additional value “51” may be used to calculate the start timing ts of the first period after the actual adjustment.

### Second Embodiment

The control signal from the remote controller 400 as the external signal for adjusting the timing of the first period is used to perform the determination of timings of the first and/or second periods described in the context of FIGS. 10 to 12. Alternatively, other signals may be also used as the external signal.

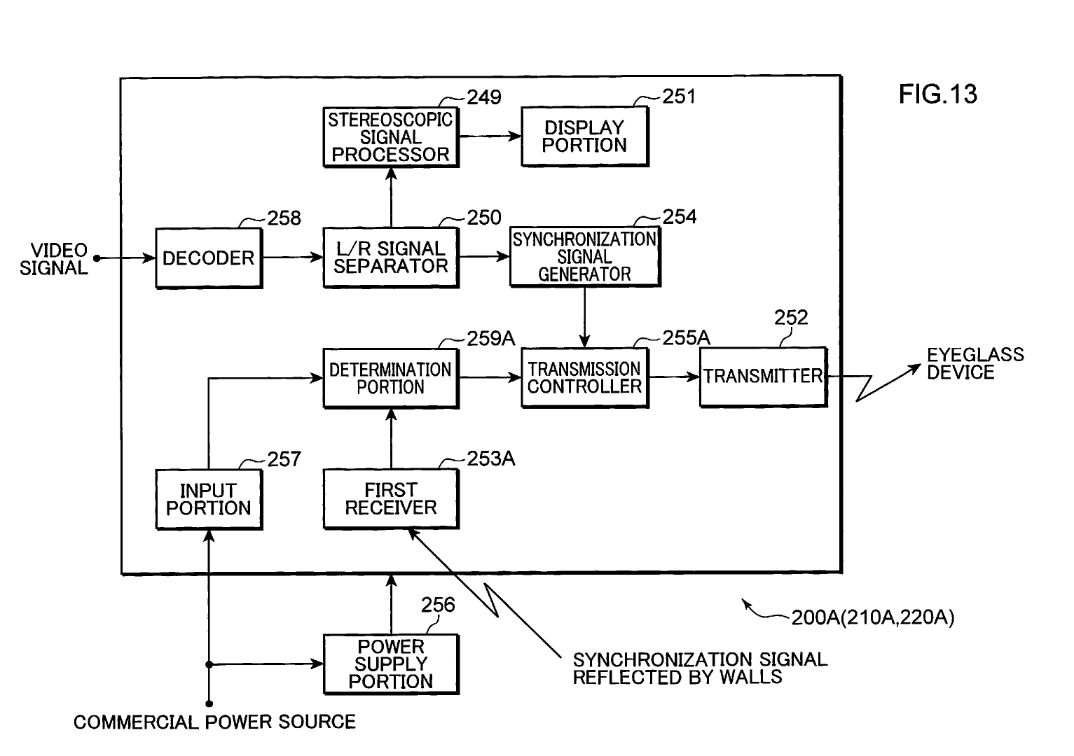

FIG. 13 is a block diagram schematically showing a functional configuration of a display device. The display device according to the second embodiment is described with reference to FIG. 13.

In the present embodiment, a first receiver 253A of the display device 200A (a first and second display devices 210A, 220A) receives synchronization signals transmitted from the first and second display devices 210A, 220A instead of the control signal from the remote controller 400 (see FIG. 1) of the first embodiment. The synchronization signals transmitted from the transmitter 252 of the first and second display devices 210A, 220A are reflected, for example, by a wall defining a space where the first and second display devices 210A, 220A are situated, and then received by the first receivers 253A of the first and second display devices 210A, 220A. The first receiver 253A outputs the information relating to the reception timings of the synchronization signals to a determination portion 259A. A transmission controller 255A outputs the information relating to the transmission timings of the synchronization signals to the determination portion 259A. On the basis of the information relating to the reception and transmission timings of the synchronization signals, the determination portion 259A determines whether or not it is necessary to adjust the timing of the first period. The other constituent elements are similar to those of the display device 200 according to the first embodiment described with reference to FIG. 5.

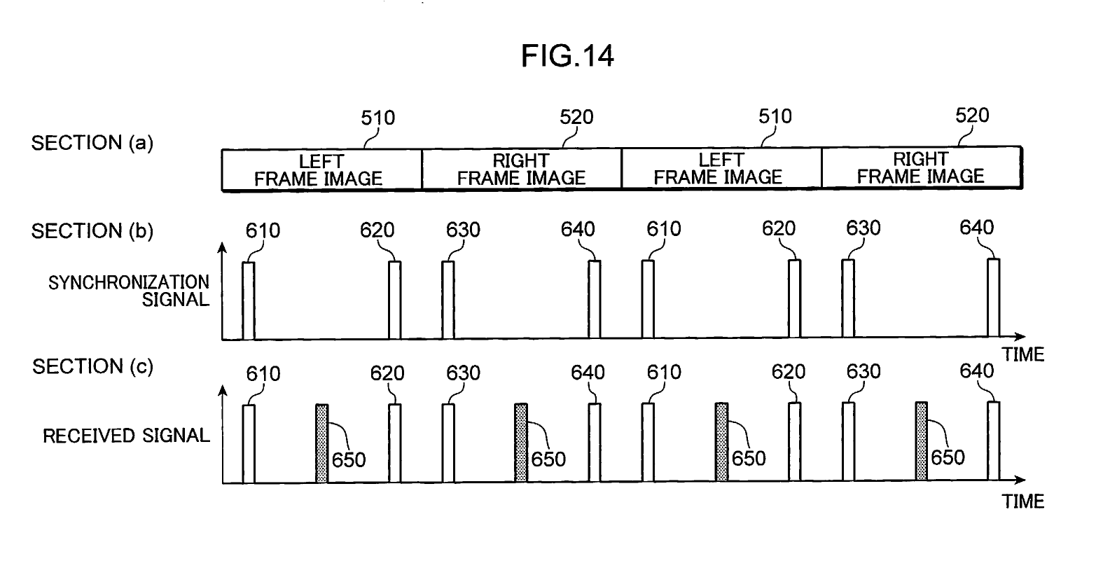

FIG. 14 is a schematic view depicting transmissions and receptions of the synchronization signals in the first display device 210A. Section (a) in FIG. 14 shows a frame image displayed by the display portion 251 of the first display device 210A. Section (b) in FIG. 14 shows the transmission of the synchronization signal from the transmitter 252 of the first display device 210A. Section (c) in FIG. 14 shows the reception of the synchronization signal by the first receiver 253A of the first display device 210A. Transmissions and receptions of the synchronization signals are described with reference to FIGS. 7, 13 and 14. The transmissions and receptions of the synchronization signals described in the context of FIG. 14 may be similarly applied to the second display device 220A.

In the first period, as described above, the transmitter 252 of the first display device 210A transmits the synchronization signals in synchronism with the display of the left and right frame images 510, 520 under control of the transmission controller 255A. In the present embodiment, the transmitter 252 transmits a synchronization signal 610 in synchronism with the display start of the left frame image 510, a synchronization signal 620 in synchronism with the display end of the left frame image 510, a synchronization signal 630 in synchronism with the display start of the right frame image 520, and a synchronization signal 640 in synchronism with the display end of the right frame image 520. The transmission controller 255A of the first display device 210A outputs information relating to the transmission timings of the synchronization signals 610, 620, 630 and 640 to the determination portion 259A.

If the first eyeglass device 310 receives the synchronization signal 610, the left filter 331 of the first eyeglass device 310 operates to allow an increased light amount to reach the left eye of the viewer. If the first eyeglass device 310 receives the synchronization signal 620, the left filter 331 of the first eyeglass device 310 operates to allow little light to reach the left eye of the viewer. If the first eyeglass device 310 receives the synchronization signal 630, the right filter 332 of the first eyeglass device 310 operates to allow an increased light amount to reach the right eye of the viewer. If the first eyeglass device 310 receives the synchronization signal 640, the right filter 332 of the first eyeglass device 310 operates to allow little light to reach the right eye of the viewer.

The synchronization signals 610, 620, 630, 640 transmitted from the transmitter 252 of the first display device 210A are reflected by some walls defining the space where the first and second display devices 210A, 220A are situated, as described above, and then received by the first receiver 253A of the first display device 210A. The first receiver 253A receives the synchronization signals 610, 620, 630, 640 at the timings substantially equal to the corresponding transmission timings of the synchronization signals 610, 620, 630, 640 and outputs information relating to the reception timings of the synchronization signals 610, 620, 630, 640 to the determination portion 259A. The determination portion 259A compares the transmission timings with the reception timings of the synchronization signals 610, 620, 630, 640. If the difference between them is within a predetermined range, it is determined that the synchronization signals 610, 620, 630, 640 received by the first receiver 253A are the first synchronization signals transmitted by the first display device 210A.

As shown in section (c) in FIG. 14, the first receiver 253A receives signals 650 in addition to the synchronization signals 610, 620, 630, 640. The first receiver 253A outputs information relating to the reception timings of the signals 650 to the determination portion 259A. The determination portion 259A compares the reception timings of the signals 650 with the transmission timings of the synchronization signals 610, 620, 630, 640. As shown in section (c) of FIG. 14, the reception timings of the signals 650 are significantly different from the transmission timings of the synchronization signals 610, 620, 630, 640. Therefore, the determination portion 259A determines that the signals 650 are the second synchronization signals transmitted from the second display device 220A.

If the signals 650 other than the synchronization signals 610, 620, 630, 640 are received within the first period which has been set by the determination portion 259A, the determination portion 259A adjusts the timing of the first period.

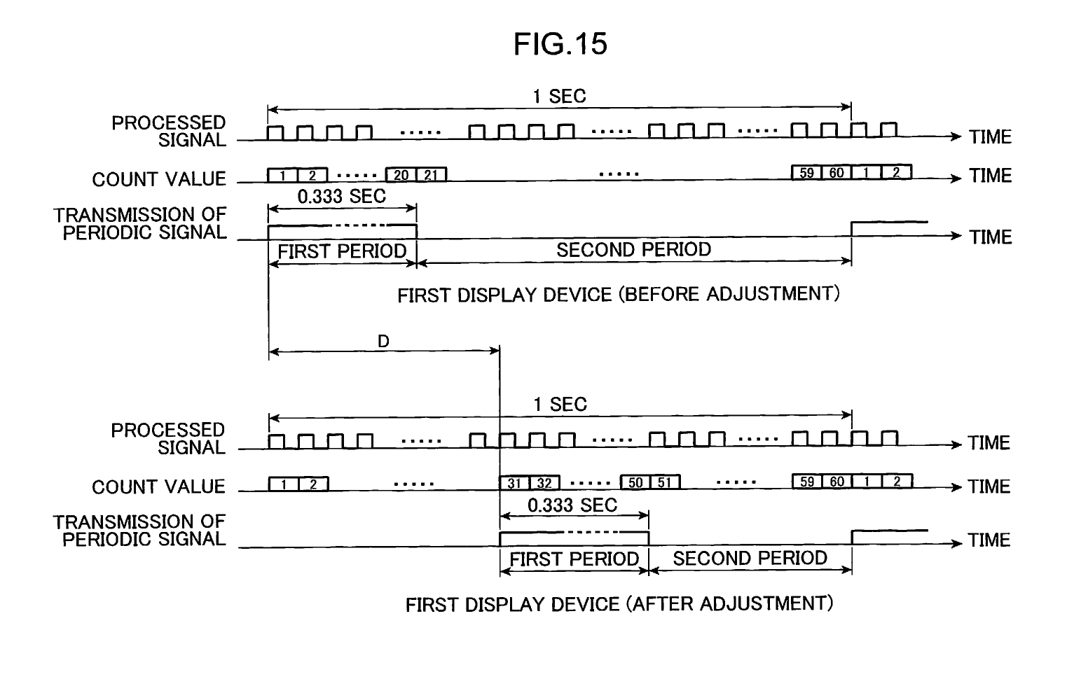

FIG. 15 schematically shows the timing adjustment of the first and/or second periods by the first display device 210A. The timing adjustment of the first and/or second periods is described hereinafter with reference to FIGS. 13 to 15.

Like the first embodiment, the determination portion 259A allocates count values on the basis of the processed signal generated by the input portion 257. Before the timing adjustments of the first and/or second periods, the determination portion 259A sets a period from the count value “1” to the count value “20” as the first period. The period from the count value “21” to the count value “60” is set as the second period.

As described in the context of FIG. 14, if the signal 650 other than the synchronization signals 610, 620, 630, 640 is received, the determination portion 259A delays the timing of the first period by a predetermined count value (delay time D) (for example, a count value of “30”). The delay amount of the first period may be determined in advance. There may be also a difference in delay amount of the first period between the first and second display devices 210A, 220A. If there is a difference in delay amount to be added between both of the display devices, it becomes less likely the timings of the first periods overlap again even when both of the display devices adjust the timings of the first periods. Each display device may determine the delay amount of the first period, for example, on the basis of random numbers.

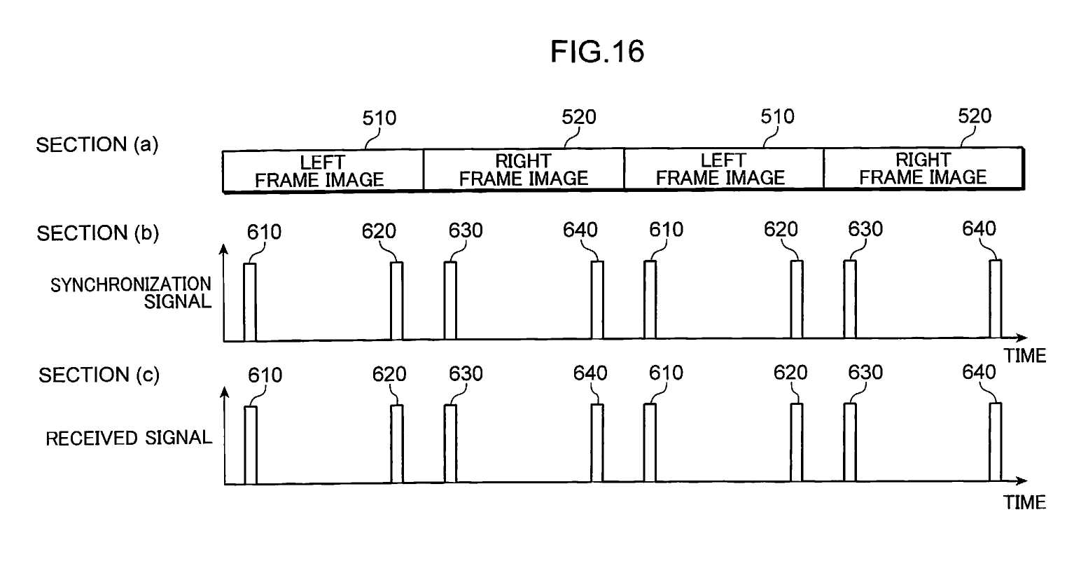

FIG. 16 is a schematic view depicting transmissions and receptions of the synchronization signals by the first display device 210A after the timing adjustments of the first and/or second periods. Section (a) in FIG. 16 shows frame images displayed by the display portion 251 of the first display device 210A. Section (b) in FIG. 16 shows the transmissions of the synchronization signals from the transmitter 252 of the first display device 210A. Section (c) in FIG. 16 shows the receptions of the synchronization signals by the first receiver 253A of the first display device 210A. Communication of the synchronization signals is described with reference to FIGS. 13, 14 and 16.

As shown in FIG. 16, after the timing adjustments of the first and/or second periods, the first display device 210A does not receive the signal 650. Therefore, the determination portion 259A of the first display device 210A determines that the first receiver 253A of the first display device 210A does not receive the second synchronization signal transmitted from the transmitter 252 of the second display device 220A within the newly determined first period. The determination portion 259A of the first display device 210A thus determines that the timing of the first period has been appropriately adjusted, and then ends the timing adjustment of the first period.

### Third Embodiment

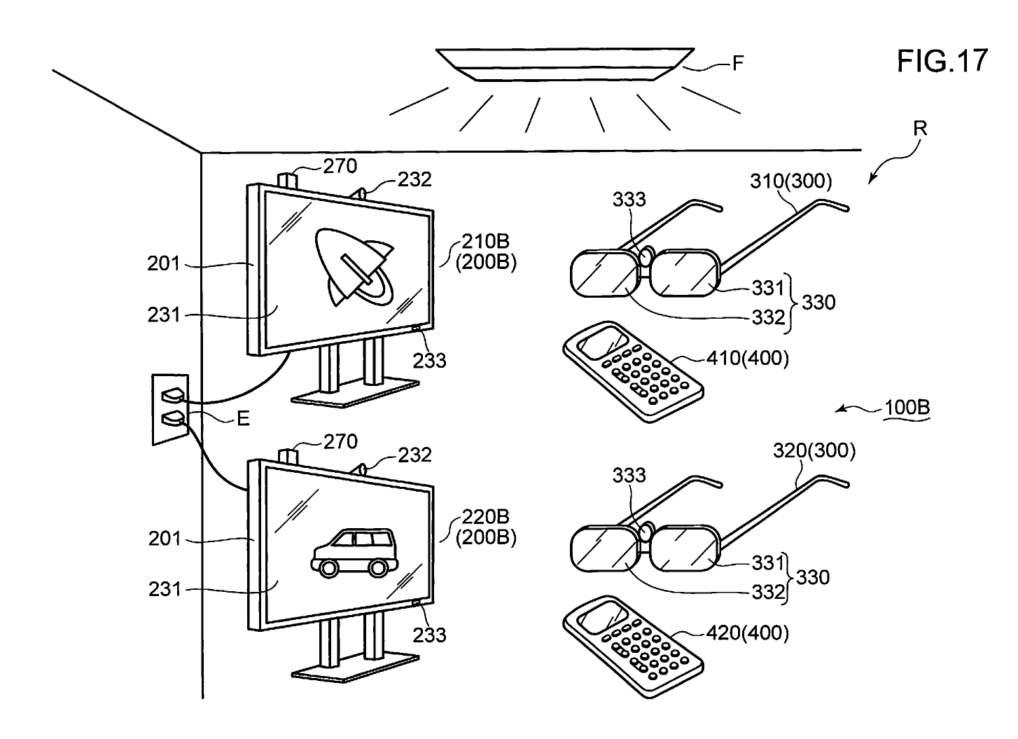

FIG. 17 schematically shows the video system according to the third embodiment. The video system shown in FIG. 17 merely serves to clarify principles of the present embodiment. Therefore, the principles of the present embodiment are not limited in any way to detailed structures, arrangements and shapes shown in FIG. 17.

A video system 100B according to the third embodiment includes a display device 200B and an eyeglass device 300. In the present embodiment, one of the methods described in the context of the first and second embodiments may be used for the timing adjustment of the first period. Therefore, if the method described in the context of the second embodiment is used, the remote controller 400 shown in FIG. 17 is not required.

The display device 200B means at least one of a first display device 210B and a second display device 220B. The first and second display devices 210B, 220B receive power supply from the commercial power source E although, in the present embodiment, the AC voltage from the commercial power source E is not used as the reference signal. In the present embodiment, blinking of light from a light source F, which is used as illumination equipment of a space R where the first and second display devices 210B, 220B are situated, is used as the reference signal instead of the AC voltage from the commercial power source E.

The display device 200B is provided with an illuminance sensor 270 configured to detect the blinking of the light from the light source F. The illuminance sensor 270 outputs a high-voltage signal if an illuminance above a predetermined value is detected and a low-voltage signal if a luminance no more than the predetermined value is detected. Thus, the illuminance sensor 270 outputs a high-voltage signal if the light source F becomes bright and a low-voltage signal when the light source F becomes dark. If the AC voltage from the commercial power source E has a frequency of 50 Hz, the light source F typically blinks at a frequency of 100 Hz. If the AC voltage of the commercial power source E has a frequency 60 Hz, the light source typically blinks at a frequency of 120 Hz. The illuminance sensor 270 detects such blinking of the light source F.

Other features of the display device 200B as well as features of the eyeglass device 300 and/or the remote controller 400 are similar to those described in the context of the first and second embodiments.

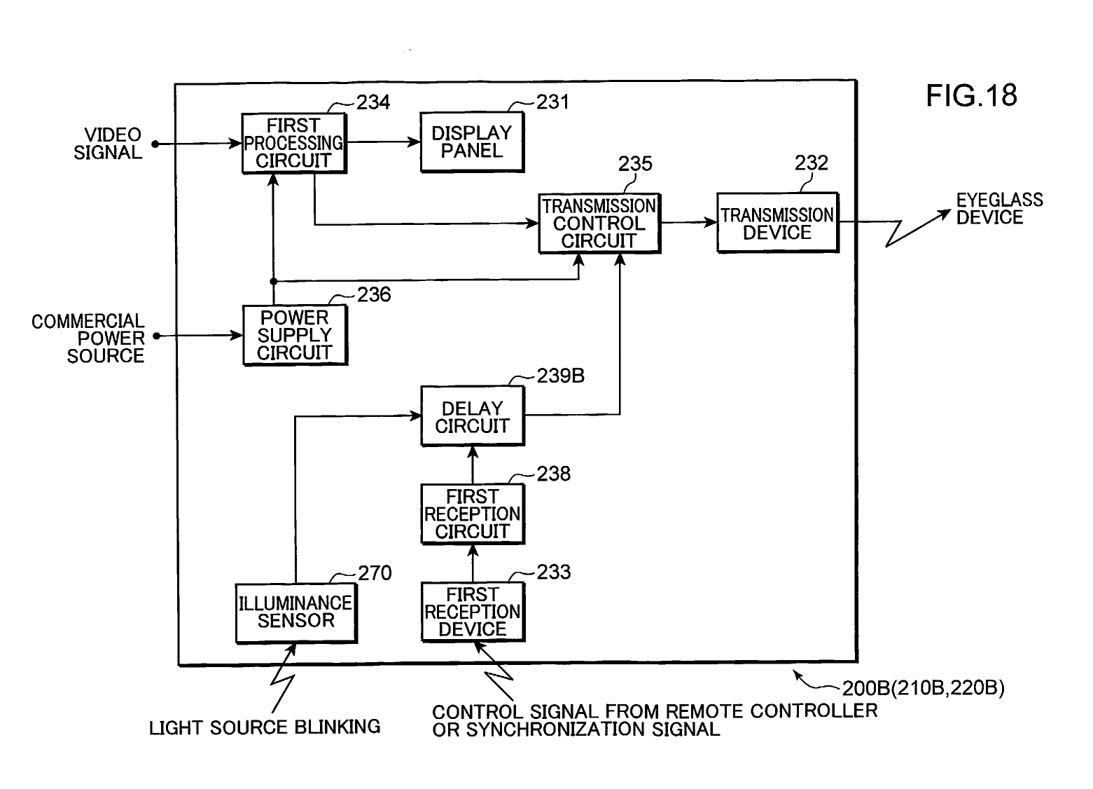

FIG. 18 is a block diagram schematically showing a hardware configuration of the display device 200B. The display device 200B is described hereinafter with reference to FIGS. 17 and 18. The first and second display devices 210B, 220B may have similar hardware configurations.

The display device 200B is provided with a first processing circuit 234, a display panel 231, a transmission control circuit 235, a transmission device 232, a power supply circuit 236, a first reception device 233, a first reception circuit 238, a delay circuit 239B, and the illuminance sensor 270.

As described above, the illuminance sensor 270 is used as a detector, which detects the blinking of the light from the light source F and outputs a detection signal to the delay circuit 239B for notifying the determination portion 259 of a frequency and phase of the blinking or a phase by the blinking cycle. The delay circuit 239B determines the transmission cycle including the first period in which the synchronization signal is transmitted and the second period in which the synchronization signal is not transmitted on the basis of the detection signal from the illuminance sensor 270.

Other features are similar to those described in the context of the first and/or second embodiments.

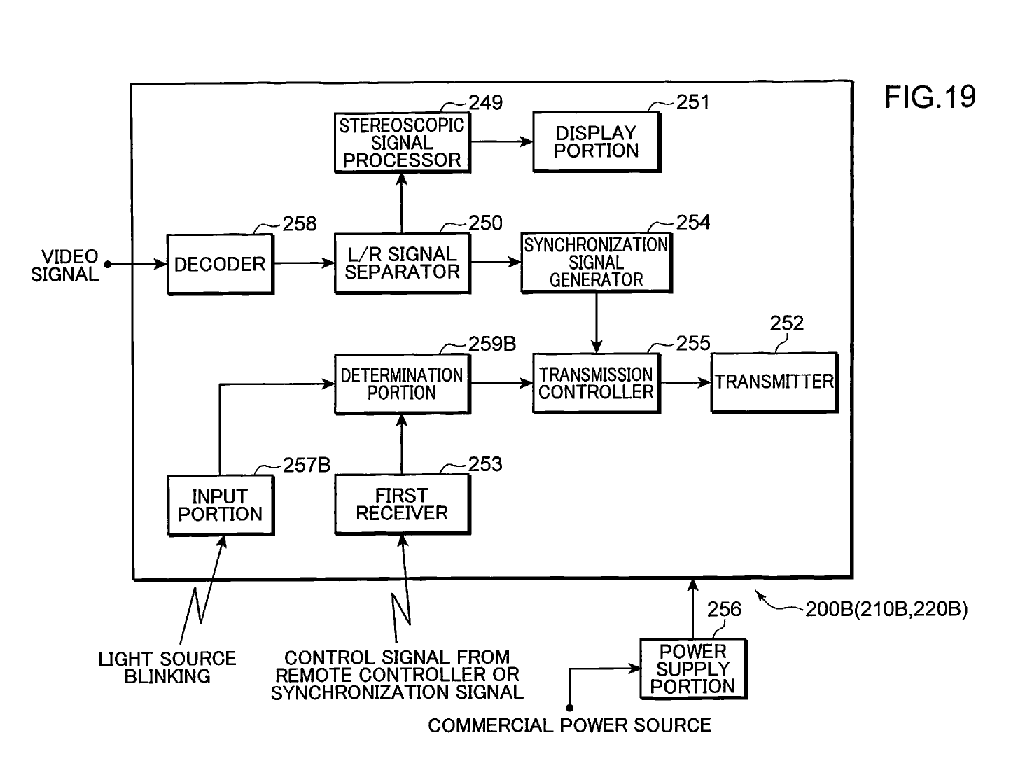

FIG. 19 is a block diagram schematically showing a functional configuration of the display device 200B. The display device 200B is described hereinafter in detail with reference to FIGS. 17 to 19.

The display device 200B is provided with a decoder 258, a L/R signal separator 250, a stereoscopic signal processor 249, a display portion 251, a synchronization signal generator 254, a transmission controller 255, a transmitter 252, a first receiver 253, a power supply portion 256, an input portion 257B, and a determination portion 259B.

In the present embodiment, the input portion 257B corresponds to the illuminance sensor 270. The input portion 257B detects the blinking of the light from the light source F and outputs the detection signal sent from the illuminance sensor 270 to the determination portion 259B, to which the light blinking frequency is therefore notified. The determination portion 259B determines the transmission cycle including the first period in which the synchronization signal is transmitted and the second period without transmission of the synchronization signal in response to the detection signal from the input portion 257B.

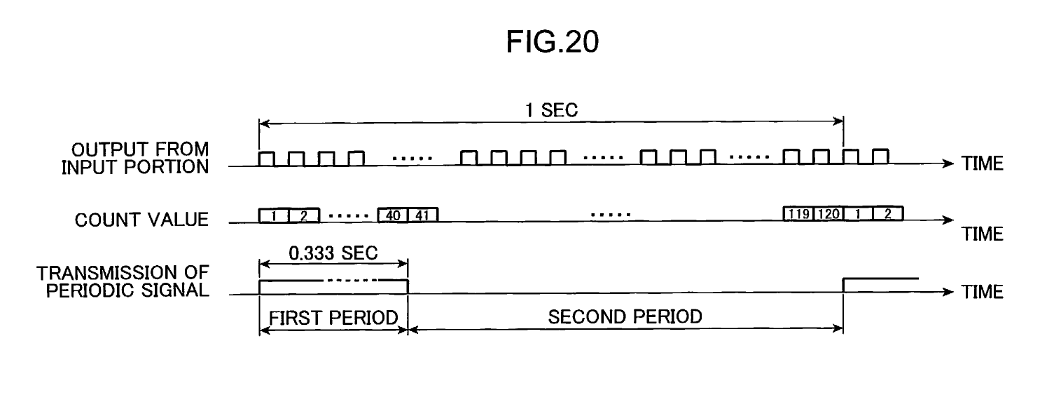

FIG. 20 is a schematic view depicting a method for determining the intermittent transmission cycle. The method for determining the intermittent transmission cycle is described hereinafter with reference to FIGS. 17 to 20.

If the light source F blinking with a frequency of 120 Hz is used as the reference signal, the illuminance sensor 270, which is used as the input portion 257B, outputs a frequency of 120 Hz of a voltage signal with a rectangular waveform. The determination portion 259B allocates count values from “1” to “120” to the rectangular wave cycles. As a result, different count values are allocated to the output wave cycles of the illuminance sensor 270 every 1 sec. The determination portion 259B determines 40 consecutive count values as the first period and the remaining count values as the second period. In FIG. 12, the period corresponding to the count values from “1” to “40” is determined as the first period in which the synchronization signal is transmitted, and the period corresponding to the count values from “41” to “120” is determined as the second period in which the synchronization signal is not transmitted.

As described in the first embodiment, a viewer wearing the eyeglass device 300 may adjust the timings of the first and/or second periods via the remote controller 400 with viewing the stereoscopic video displayed on the display portion 251. Alternatively, as described in the second embodiment, the determination portion 259B may adjust the timings of the first and/or second periods with comparing the transmission timings of the synchronization signals transmitted from the transmitter 252 to the reception timings of the synchronization signals received by the first receiver 253.

### Application of Multiple Display Devices

The first to third embodiments show methodologies to decrease the synchronization signal interference between the two display devices 200, 200A, 200B (first display device 210, 210A, 210B and second display device 220, 220A, 220B). Alternatively the aforementioned methodologies may be also applied to three or more display devices.

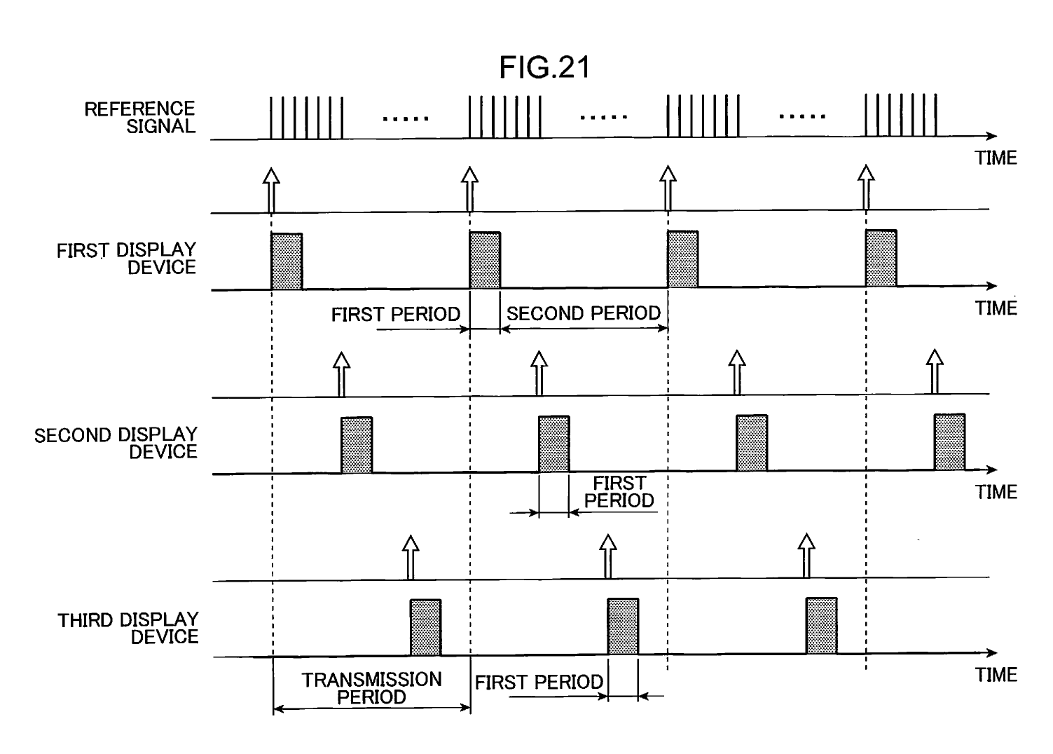

FIG. 21 schematically shows methodologies to decrease interference between synchronization signals. The methodologies may be applied to a video system including three display devices (first display device, second display device, and third display device).

The first to third display devices determine the intermittent transmission cycle, which includes the first period and the second period, on the basis of a common reference signal (for example, a commercial power source or a light source). The transmission cycles determined by the first to third display devices thus become equal to each other.

The first to third display devices determine an identical length of the first periods within the determined transmission cycle. As described above, the length of the first period is preferably determined by the cycle of the common reference signal (i.e. by using a count value). The first to third display devices adjust the timings of the first periods so that the first periods do not overlap with each other. As described above, the timings of the first periods are adjusted (shifted) by the cycle of the common reference signal. Therefore, it is facilitated to determine the time positions of the first periods so that the time positions of the first periods do not overlap with each other.

### Other Reference Signals

In the aforementioned series of embodiments, the commercial power supply or indoor lamp are exemplifed as the reference signal to be used between/among two or more of display devices. Alternatively, signals from other signal sources may be used as the reference signal. For example, a signal generated by a signal generator electrically connected to the display devices may be appropriately used as the reference signal. The use of the signal generator connected to the display devices as a reference signal source may make mechanical or electrical setup for supplying the reference signal to a lot of display devices more simplified.

The aforementioned embodiments mainly include the following features.

A display device according to the aforementioned embodiments for transmitting a first synchronization signal which is synchronized with display of a video frame image includes: an input portion into which a reference signal with a predetermined frequency is input, the reference signal serving as a reference to be used by another display device configured to intermittently transmit a second synchronization signal on a predetermined transmission cycle; a determination portion configured to determine an intermittent transmission cycle based on the reference signal so that the intermittent transmission cycle becomes as long as the predetermined transmission cycle and includes a first period during which the first synchronization signal is transmitted and a second period without transmission of the first synchronization signal; and a transmitter which transmits the first synchronization signal during the first period except for the second period, wherein the determination portion adjusts a timing of the first period to avoid interference between the first and second synchronization signals.

According to the aforementioned configuration, the determination portion determines the intermittent transmission cycle on the basis of the predetermined frequency of the reference signal input to the input portion so that the intermittent transmission cycle includes the first period in which the synchronization signal is transmitted and the second period without the synchronization signal transmission. The transmitter transmits the first synchronization signal in synchronism with the video frame image during the first period whereas the transmitter does not transmit the first synchronization signal during the second period. The determination portion determines the transmission cycle which is as long as the transmission cycle of the second synchronization signal from the other display device with adjusting the timing of the first period so as to avoid interference between the first and second synchronization signals. Therefore, it becomes less likely that there is the interference between the first and second synchronization signals.

In the aforementioned configuration, it is preferred that the determination portion adjusts the timing of the first period by a cycle of the reference signal.

According to the aforementioned configuration, the determination portion adjusts the timing of the first period by the cycle of the reference signal. The other display device also transmits the second synchronization signal in response to the reference signal. Therefore, as a result of the adjustment of the timing of the first period by the cycle of the reference signal, it becomes likely that the timing of the first period is appropriately shifted from the transmission of the second synchronization signal. Therefore it becomes less likely that there is interference between the first and second synchronization signals.

In the aforementioned configuration, it is preferred that the display device further comprises a first receiver which receives an external signal to adjust the timing of the first period, wherein the determination portion adjusts the timing of the first period based on the external signal.

According to the aforementioned configuration, the timing of the first period is preferably adjusted on the basis of the external signal.

In the aforementioned configuration, it is preferred that the external signal includes a signal transmitted from a remote controller configured to control the display device.

According to the aforementioned configuration, the timing of the first period is preferably adjusted on the basis of a signal from the remote controller.

In the aforementioned configuration, it is preferred that the external signal includes the second synchronization signal received by the first receiver of the display device, and the determination portion adjusts the timing of the first period so that the first receiver does not receive the second synchronization signal during the first period.

According to the aforementioned configuration, the determination portion adjusts the timing of the first period so that the first receiver does not receive the second synchronization signal during the first period. Therefore, the determination portion may adjust the timing of the first period so that the first synchronization signal is less likely to interfere with the second synchronization signal. Thus it becomes less likely that there is interference between the first and second synchronization signals.

In the aforementioned configuration, it is preferred that the reference signal includes an AC voltage from a commercial power source for supplying power to both display devices, and the input portion includes a waveform shaper configured to shape a waveform of the AC voltage so that the determination portion reads a frequency or phase of the AC voltage.

According to the aforementioned configuration, since the AC voltage from the commercial power source is used as the reference signal, the reference signal is generated without any dedicated apparatus.

In the aforementioned configuration, it is preferred that the reference signal includes blinking of a light source configured to illuminate a space in which both display devices are situated, and the input portion includes a detector which detects the blinking of the light source to output a detection signal to the determination portion for notifying a frequency or phase of the blinking of the light source.

According to the aforementioned configuration, since the blinking of the light source is used as the reference signal, the reference signal is generated without any dedicated apparatus.

A video system according to the aforementioned embodiments includes a first display device configured to display a first video; a second display device configured to display a second video; a first eyeglass device configured to assist in viewing the first video; and a second eyeglass device configured to assist in viewing the second video, wherein each of the first and second display devices comprises: an input portion into which a reference signal with a predetermined frequency is input; a transmitter configured to transmit a synchronization signal which is synchronized with a frame image of a video; a determination portion configured to determine an intermittent transmission cycle including a first period during which the synchronization signal is transmitted and a second period without transmission of the synchronization signal; and a transmission controller configured to control the transmitter so that the synchronization signal is transmitted in the first period except for the second period, each of the first and second eyeglass devices comprises: a second receiver configured to receive the synchronization signal; an optical filter portion configured to adjust a light amount from the video; and a controller configured to control the optical filter portion based on the synchronization signal received during the first period, the determination portions of the first and second display devices determine the transmission cycle based on the reference signal, the determination portion of the first display device adjusts and prevents a timing of the first period from overlapping with a timing of the first period determined by the determination portion of the second display device to avoid interference between the synchronization signals from the first and second display devices, the second receiver of the first eyeglass device receives the synchronization signal from the first display device, and the second receiver of the second eyeglass device receives the synchronization signal from the second display device.

According to the aforementioned configuration, the first display device displays the first video while the first eyeglass device assists in viewing the first video. The second display device displays the second video while the second eyeglass device assists in viewing the second video. The determination portions of the first and second display devices determine the transmission cycle including the first period in which the synchronization signal is transmitted and the second period without the transmission of the synchronization signal on the basis of the predetermined frequency of the reference signal. The transmitters of the first and second display devices transmit the synchronization signal in synchronism with the video frame image during the first period whereas the transmitters do not transmit the synchronization signal during the second period. The determination portions of the first and second display devices determine the transmission cycles on the basis of the reference signal. The determination portion of the first display device adjusts and prevents the timing of the first period from overlapping with the timing of the first period determined by the determination portion of the second display device. Therefore it becomes less likely that there is interference between the synchronization signals from the first and second display devices. The second receiver of the first eyeglass device receives the synchronization signal from the first display device. The first eyeglass device configured to appropriately assist in viewing the first video becomes less sensitive to the synchronization signal from the second display device. Similarly, the second receiver of the second eyeglass device receives the synchronization signal from the second display device. The second eyeglass device configured to appropriately assist in viewing the second video becomes less sensitive to the synchronization signal from the first display device.

### INDUSTRIAL APPLICABILITY

The present invention may be preferably used in technologies for stereoscopically viewing videos.

1. A display device for transmitting a first synchronization signal which is synchronized with display of a video frame image, comprising:
an input portion into which a reference signal with a predetermined frequency is input, the reference signal serving as a reference to be used by another display device configured to intermittently transmit a second synchronization signal on a predetermined transmission cycle;
a determination portion configured to determine an intermittent transmission cycle based on the reference signal so that the intermittent transmission cycle becomes as long as the predetermined transmission cycle and includes a first period during which the first synchronization signal is transmitted and a second period without transmission of the first synchronization signal; and
a transmitter which transmits the first synchronization signal during the first period except for the second period, wherein
the determination portion adjusts a timing of the first period to avoid interference between the first and second synchronization signals.

2. The display device according to claim 1, wherein the determination portion adjusts the timing of the first period by a cycle of the reference signal.

3. The display device according to claim 2, further comprising:
a first receiver which receives an external signal to adjust the timing of the first period, wherein
the determination portion adjusts the timing of the first period based on the external signal.

4. The display device according to claim 3, wherein the external signal includes a signal transmitted from a remote controller configured to control the display device.

5. The display device according to claim 3, wherein
the external signal includes the second synchronization signal received by the first receiver of the display device, and
the determination portion adjusts the timing of the first period so that the first receiver does not receive the second synchronization signal during the first period.

6. The display device according to claim 2, wherein
the reference signal includes an AC voltage from a commercial power source for supplying power to both display devices, and
the input portion includes a waveform shaper configured to shape a waveform of the AC voltage so that the determination portion reads a frequency or phase of the AC voltage.

7. The display device according to claim 2, wherein
the reference signal includes blinking of a light source configured to illuminate a space in which both display devices are situated, and
the input portion includes a detector which detects the blinking of the light source to output a detection signal to the determination portion for notifying a frequency or phase of the blinking of the light source.

8. A video system, comprising:
a first display device configured to display a first video;
a second display device configured to display a second video;
a first eyeglass device configured to assist in viewing the first video; and
a second eyeglass device configured to assist in viewing the second video, wherein each of the first and second display devices comprises:
an input portion into which a reference signal with a predetermined frequency is input;
a transmitter configured to transmit a synchronization signal which is synchronized with a frame image of a video;
a determination portion configured to determine an intermittent transmission cycle including a first period during which the synchronization signal is transmitted and a second period without transmission of the synchronization signal; and
a transmission controller configured to control the transmitter so that the synchronization signal is transmitted in the first period except for the second period,
each of the first and second eyeglass devices comprises:
a second receiver configured to receive the synchronization signal;
an optical filter portion configured to adjust a light amount from the video; and
a controller configured to control the optical filter portion based on the synchronization signal received during the first period,
the determination portions of the first and second display devices determine the transmission cycle based on the reference signal,
the determination portion of the first display device adjusts and prevents a timing of the first period from overlapping with a timing of the first period determined by the determination portion of the second display device to avoid interference between the synchronization signals from the first and second display devices,
the second receiver of the first eyeglass device receives the synchronization signal from the first display device, and
the second receiver of the second eyeglass device receives the synchronization signal from the second display device.
